(19) United States
(12) Patent Application Publication
(10) Pub. No.: US 2017/0054907 A1
(43) Pub. Date: Feb. 23, 2017

(54) SAFETY EQUIPMENT, IMAGE COMMUNICATION SYSTEM, METHOD FOR CONTROLLING LIGHT EMISSION, AND NON-TRANSITORY RECORDING MEDIUM

(71) Applicants: Yoshito NISHIHARA, Tokyo (JP); Tadashi ARAKI, Kanagawa (JP); Aiko OHTSUKA, Tokyo (JP)

(72) Inventors: Yoshito NISHIHARA, Tokyo (JP); Tadashi ARAKI, Kanagawa (JP); Aiko OHTSUKA, Tokyo (JP)

(21) Appl. No.: 15/237,821

(22) Filed: Aug. 16, 2016

(30) Foreign Application Priority Data
Aug. 21, 2015 (JP) 2015-163933
Aug. 12, 2016 (JP) 2016-158529

(51) Int. Cl. H04N 5/232

(52) U.S. Cl. CPC H04N 5/23238; H04N 5/23206

(57) ABSTRACT

A safety equipment includes a mounting part, circuitry, and a transmitter. An image capturing device is detachably mounted to the mounting part of the safety equipment. The image capturing device captures an image of an object to acquire data of a full spherical panoramic image. The circuitry acquires the data of the full spherical panoramic image from the image capturing device mounted to the mounting part. The transmitter transmits the acquired data of the full spherical panoramic image to a communication terminal through a communication network. The communication terminal outputs an image based on the acquired data of the full spherical panoramic image.

### CROSS-REFERENCE TO RELATED APPLICATIONS

This patent application is based on and claims priority pursuant to 35 U.S.C. §119(a) to Japanese Patent Application Nos. 2015-163933, filed on Aug. 21, 2015, and 2016-158529, filed on Aug. 12, 2016 in the Japan Patent Office, the entire disclosures of which are hereby incorporated by reference herein.

### BACKGROUND

Technical Field

The present disclosure relates to a safety equipment, an image communication system, a method for controlling light emission, and a non-transitory recording medium.

Description of the Related Art

Some recent digital cameras allow a user to capture a 360-degree full spherical panoramic image surrounding the user.

The full spherical panoramic image taken by the 360-degree full spherical camera is sometimes not suitable for viewing because the image looks curved. To address this issue, an image of a predetermined area, which is a part of the full spherical panoramic image, is displayed on smartphones and the like, allowing the user to view a planar image in a similar way to viewing an image taken by typical digital cameras.

Further, some remote monitoring systems allow a user at a remote location or a construction site and the like to view and monitor video captured by a digital camera such as a web camera that is located in the construction site. In construction sites and the like, the camera is often fixed on walls, columns, or poles for monitoring a specific position. Furthermore, the user sometimes wants to view images or videos captured by the camera placed at a remote location such as the construction site for keeping track of work progress. In view of this need, the 360-degree camera is preferable compared with the typical digital camera because the single 360-degree camera can capture entire surrounding. The 360-degree camera is effective especially when placed at the center or almost the center of a space to be captured in order to capture the construction sites and the like from the inside, while the typical digital cameras are placed on walls, columns, or poles. In addition, a situation of the sites changes day to day while the construction is in progress. Therefore, it is preferable to change the position of the 360-degree camera in a simple manner according to the situations of the construction site, instead of fixing the camera at a specific position for a long period of time.

### SUMMARY

A safety equipment includes a mounting part, circuitry, and a transmitter. An image capturing device is detachably mounted to the mounting part of the safety equipment. The image capturing device captures an image of an object to acquire data of a full spherical panoramic image. The circuitry acquires the data of the full spherical panoramic image from the image capturing device mounted to the mounting part. The transmitter transmits the acquired data of the full spherical panoramic image to a communication terminal through a communication network. The communication terminal outputs an image based on the acquired data of the full spherical panoramic image.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1A is a left side view of an image capturing device according to an embodiment of the present invention;

FIG. 1B is a front view of the image capturing device of FIG. 1A;

FIG. 1C is a plan view of the image capturing device of FIG. 1A;

FIG. 2 is an illustration for explaining how a user uses the image capturing device according to an embodiment of the present invention;

FIG. 3A is a view illustrating a front side of a hemispherical image captured by the image capturing device according to an embodiment of the present invention;

FIG. 3B is a view illustrating a back side of the hemispherical image captured by the image capturing device according to an embodiment of the present invention;

FIG. 3C is a view illustrating an image captured by the image capturing device represented by Mercator projection according to an embodiment of the present invention;

FIG. 4A is an illustration for explaining how the image represented by Mercator projection covers a surface of a sphere according to an embodiment of the present invention;

FIG. 4B is a view illustrating a full spherical panoramic image according to an embodiment of the present invention;

FIG. 5 is a view illustrating positions of a virtual camera and a predetermined area in a case where the full spherical panoramic image is represented as a three-dimensional solid sphere;

FIG. 6A is a perspective view of FIG. 5;

FIG. 6B is a view illustrating an image of the predetermined area on a display of a communication terminal according to an embodiment of the present invention;

FIG. 7 is a view illustrating a relation between predetermined-area information and a predetermined-area image;

FIG. 8 is a schematic diagram illustrating a configuration of an image communication system according to an embodiment of the present invention;

FIG. 9 is a schematic block diagram illustrating a hardware configuration of the image capturing device according to an embodiment of the present invention;

FIG. 10A is a perspective view of the communication terminal according to an embodiment of the present invention;

FIG. 10B is a perspective view of a mounting part according to an embodiment of the present invention;

FIG. 11A is a plan view of the communication terminal of FIG. 10A;

FIG. 11B is a side view of the communication terminal of FIG. 10A;

FIG. 12A is a plan view of an irradiation position control unit according to an embodiment of the present invention;

FIG. 12B is a cross-sectional view of the irradiation position control unit taken through line A-A of FIG. 12A;

FIG. 12C is a cross-sectional view of the irradiation position control unit taken through line B-B of FIG. 12A;

FIG. 13 is a block diagram illustrating a hardware configuration of the communication terminal according to an embodiment of the present invention;

FIG. 14 is a block diagram illustrating a hardware configuration of any one of an image management system and a communication terminal according to an embodiment of the present invention;

FIG. 15 is a block diagram illustrating a functional configuration the image communication system according to an embodiment of the present invention;

FIG. 16 is an example of a site management table according to an embodiment of the present invention;

FIG. 17 is an example of a terminal management table according to an embodiment of the present invention;

FIG. 18 is an example of an image capturing management table according to an embodiment of the present invention;

FIG. 19 is an example of an image management table according to an embodiment of the present invention;

FIG. 20 is a view illustrating an example of a site layout map according to an embodiment of the present invention;

FIG. 21 is a sequence diagram illustrating an operation of making a reservation for image capturing according to an embodiment of the present invention;

FIG. 22 is a sequence diagram illustrating an operation of instructing image capturing according to an embodiment of the present invention;

FIG. 23 is a sequence diagram illustrating an operation of displaying a layout map according to an embodiment of the present invention;

FIGS. 24A and 24B are a sequence diagram illustrating an operation of displaying captured image data according to an embodiment of the present invention;

FIGS. 25A and 25B each is a view illustrating an example of a screen displayed on the communication terminal used by a supervisor according to an embodiment of the present invention;

FIGS. 26A and 26B each is a view illustrating an example of a screen displayed on the communication terminal used by a supervisor according to an embodiment of the present invention;

FIGS. 27A and 27B each is a view illustrating an example of a screen displayed on the communication terminal used by a supervisor according to an embodiment of the present invention;

FIG. 28 is a view illustrating an example of a screen displayed on the communication terminal used by a supervisor according to an embodiment of the present invention;

FIG. 29 is a view illustrating an example of a screen displayed on the communication terminal used by a supervisor according to an embodiment of the present invention;

FIG. 30 is a view illustrating an example of a screen displayed on the communication terminal used by a supervisor according to an embodiment of the present invention;

FIG. 31 is a view illustrating an example of a screen displayed on the communication terminal used by a supervisor according to an embodiment of the present invention;

FIG. 32 is an illustration for explaining how image capturing is performed according to an embodiment of the present invention;

FIG. 33 is a flowchart illustrating an operation of controlling a movement of an irradiation position of an irradiation image according to an embodiment of the present invention;

FIGS. 34A and 34B are each a view illustrating an example of a screen for explaining a relation between a cursor and the irradiated position of the irradiation image according to an embodiment of the present invention, and

FIG. 35 is an illustration for explaining a relation between the cursor and the irradiated position of the irradiation image according to an embodiment of the present invention.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

In the drawings for describing the following embodiments, the same reference numbers are allocated to elements (members or components) having the same function or shape and redundant descriptions thereof are omitted below.

An example embodiment of the present invention will be described hereinafter with reference to drawings.

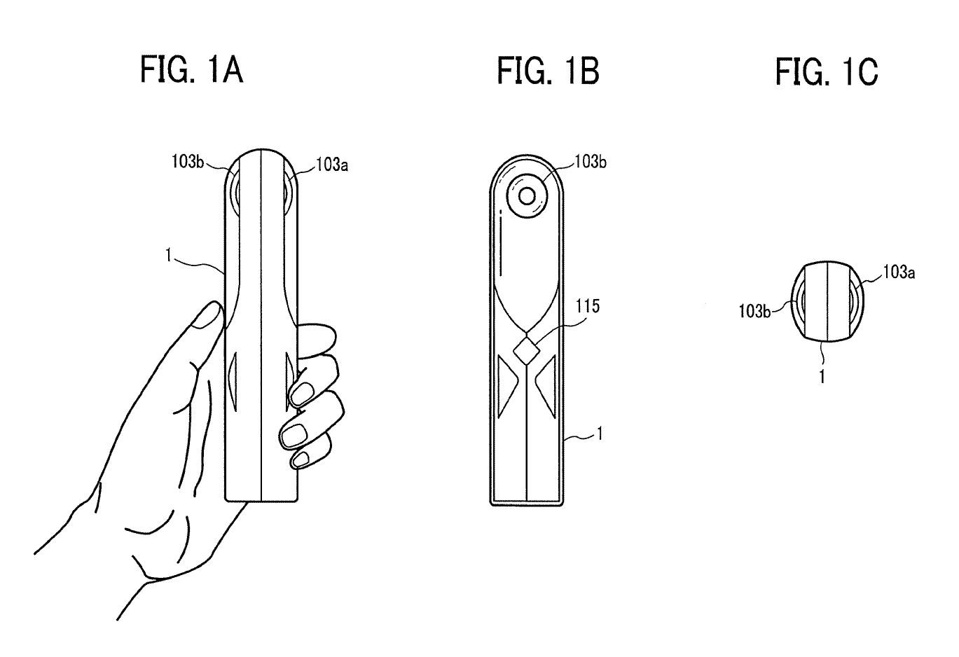

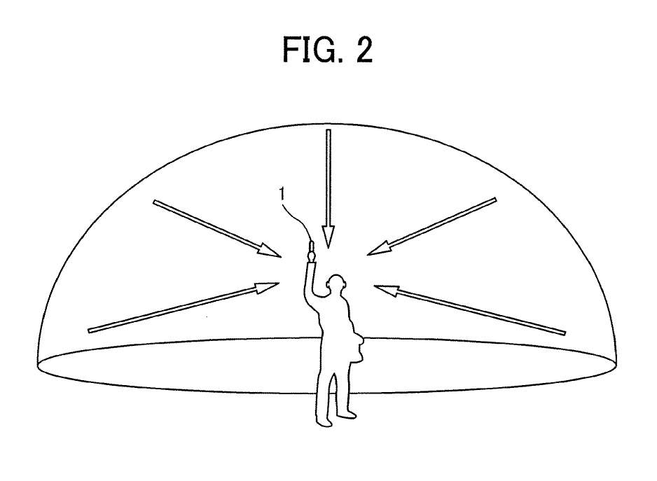

First, a description is given of an operation of generating a full spherical panoramic image with reference to FIGS. 1 to 7.

Hereinafter, a description is given of an external view of an image capturing device 1 with reference to FIGS. 1A to 1C. The image capturing device 1 is a digital camera for acquiring captured images from which a 360-degree full spherical panoramic image is generated. FIGS. 1A to 1C are respectively a left side view, a front view, and a plan view of the image capturing device 1.

As illustrated in FIG. 1A, the image capturing device 1 has a shape such that one can hold it with one hand. Further, as illustrated in FIGS. 1A to 1C, an image pickup device 103a is provided on a front side (anterior side) of an upper section of the image capturing device 1, and an image pickup device 103b is provided on a back side (rear side) thereof. These image pickup devices 103a and 103b are respectively used with optical members (e.g., fisheye lenses 102a and 102b), each being capable of capturing a semi spherical image (180-degree or more angle of view). Furthermore, as illustrated in FIG. 1B, an operation unit 115 such as a shutter button is provided on the back side (rear side) of the image capturing device 1.

Hereinafter, a description is given of a situation where the image capturing device 1 is used with reference to FIG. 2. FIG. 2 is an example illustration for explaining how a user uses the image capturing device 1. As illustrated in FIG. 2, for example, the image capturing device 1 is used for capturing objects surrounding the user who is holding the image capturing device 1 in his/her hand. The image pickup devices 103a and 103b illustrated in FIGS. 1A to 1C capture the objects surrounding the user to obtain two hemispherical images.

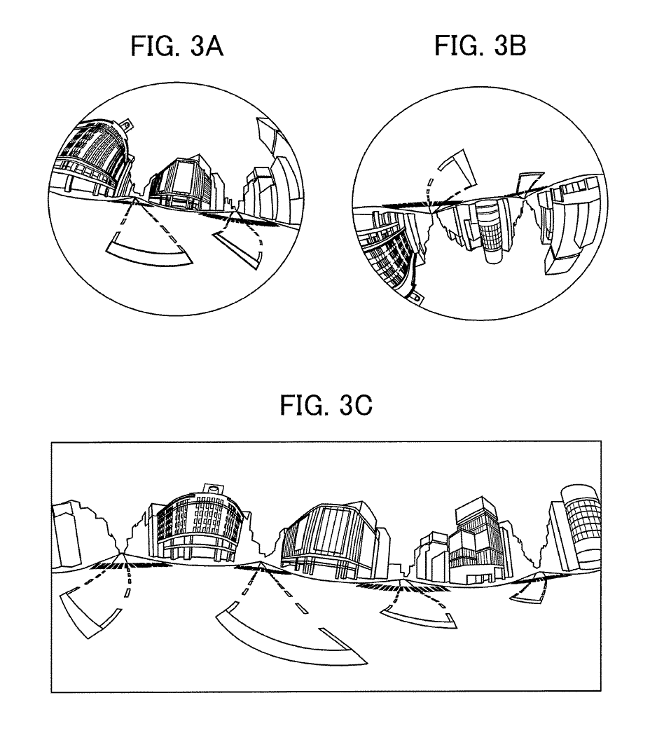

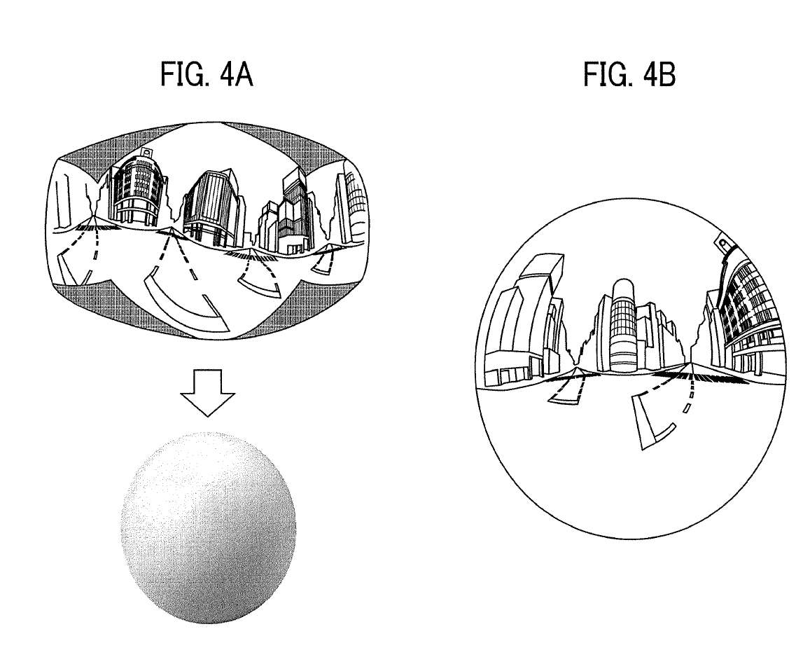

Hereinafter, a description is given of an overview of an operation of generating the full spherical panoramic image from the image captured by the image capturing device 1. FIG. 3A is a view illustrating a front side of a hemispherical image captured by the image capturing device 1. FIG. 3B is a view illustrating a back side of the hemispherical image captured by the image capturing device 1. FIG. 3C is view illustrating an image represented by Mercator projection. The image represented by Mercator projection as illustrated in FIG. 3C is referred to as a “Mercator image” hereinafter. FIG. 4A is an illustration for explaining how the Mercator image covers a surface of a sphere. FIG. 4B is a view illustrating the full spherical panoramic image.

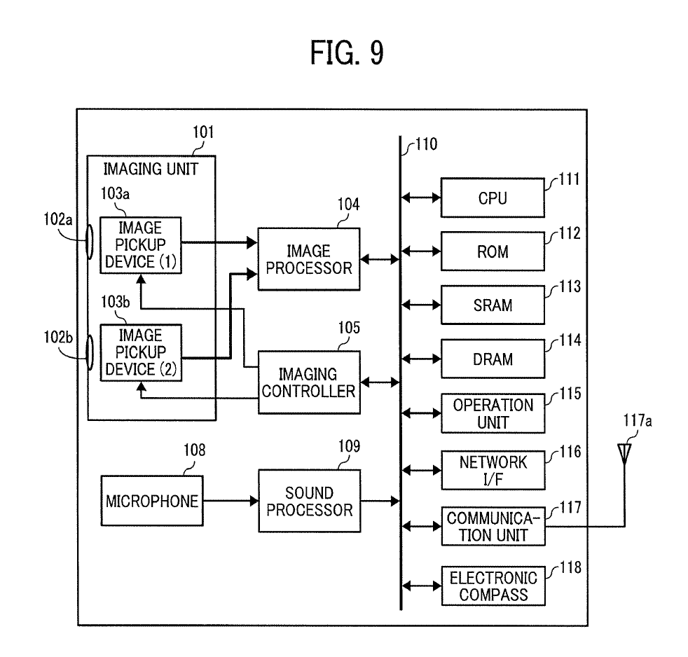

As illustrated in FIG. 3A, the image captured by the image pickup device 103a is a curved hemispherical image (front side) taken through a fisheye lens 102a (FIG. 9). Also, as illustrated in FIG. 3B, the image captured by the image pickup device 103b is a curved hemispherical image (back side) taken through a fisheye lens 102b (FIG. 9). The image capturing device 1 combines the hemispherical image (front side) and the hemispherical image (back side), which is reversed by 180-degree from, to generate the Mercator image as illustrated in FIG. 3C.

The Mercator image is pasted on the sphere surface using Open Graphics Library for Embedded Systems (OpenGL ES) as illustrated in FIG. 4A. Thus, the full spherical panoramic image as illustrated in FIG. 4B is generated. In other words, the full spherical panoramic image is represented as the Mercator image facing toward a center of the sphere. Note that OpenGL ES is a graphic library used for visualizing two-dimensional (2D) and three-dimensional (3D) data. The full spherical panoramic image is either a still image or a movie.

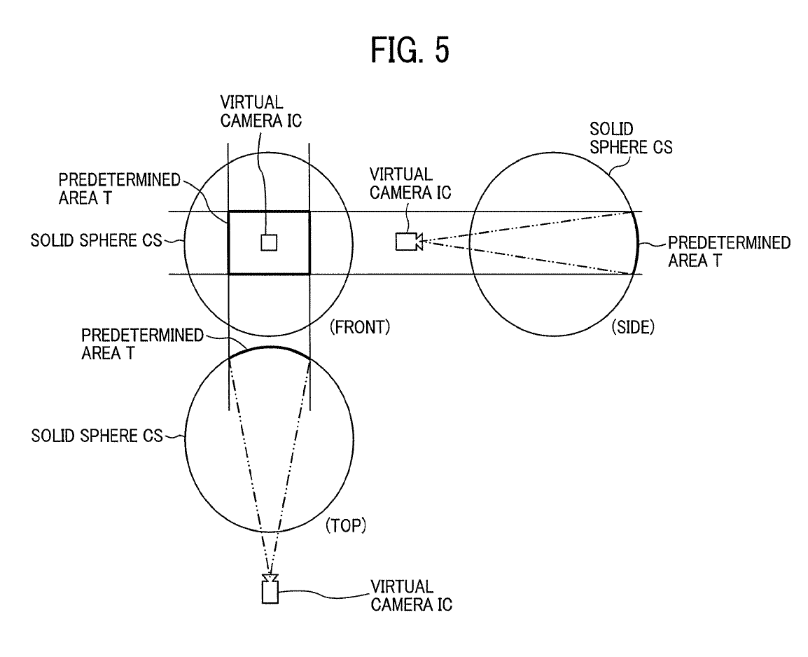

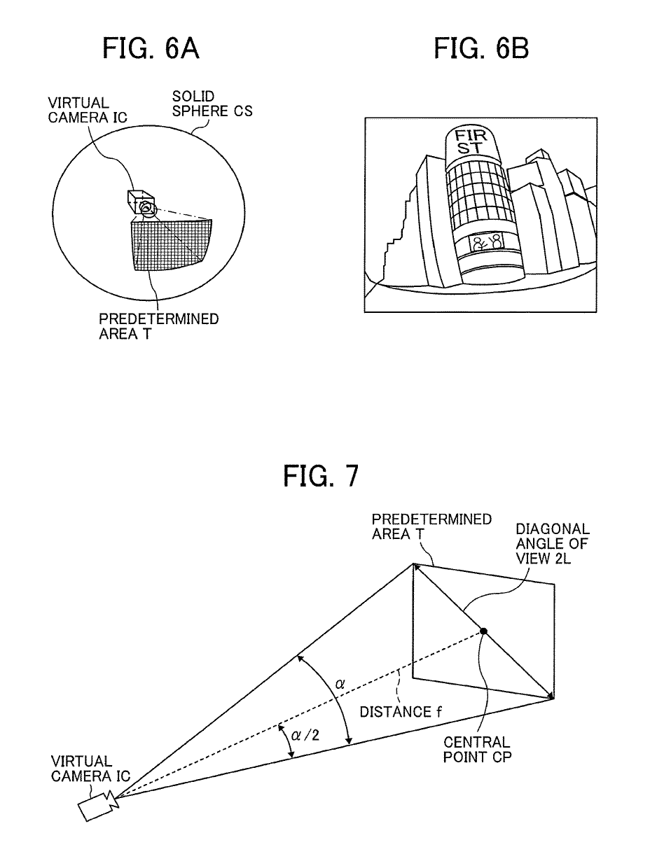

One may feel strange as viewing the full spherical panoramic image, because the full spherical panoramic image is an image pasted on the sphere surface. To resolve this strange feeling, an image of a predetermined area, which is a part of the full spherical panoramic image, is displayed as a planar image having less curves. The image of the predetermined area is referred to as a “predetermined area image” hereinafter. Hereinafter, a description is given of displaying the predetermined-area image with reference to FIGS. 5, 6A and 6B.

FIG. 5 is a view illustrating positions of a virtual camera IC and a predetermined area T in a case where the full spherical panoramic image is represented as a three-dimensional solid sphere. The virtual camera IC corresponds to a position of a point of view of a user who is viewing the full spherical panoramic image represented as the three-dimensional solid sphere. FIG. 6A is a perspective view of FIG. 5. FIG. 6B is a view illustrating the predetermined-area image displayed on a display. In FIG. 6A, the full spherical panoramic image illustrated in FIG. 4B is illustrated as a three-dimensional solid sphere CS. Assuming that the generated full spherical panoramic image is the solid sphere CS, the virtual camera IC is outside of the full spherical panoramic image as illustrated in FIG. 5. The predetermined area T in the full spherical panoramic image is specified by predetermined-area information of the position of the virtual camera IC in the full spherical panoramic image. This predetermined-area information is represented by a coordinate (x (rH), y (rV), and angle of view α (angle)) or a coordinate (X, Y, Z). Zooming of the predetermined area T is implemented by enlarging or reducing a range of the angle of view α. In other words, zooming of the predetermined area T is implemented by enlarging or reducing an arc. Further, zooming of the predetermined area T is implemented by moving the virtual camera IC toward or away from the full spherical panoramic image.

An image is of the predetermined area T in the full spherical panoramic image illustrated in FIG. 6A is displayed on a display as the predetermined-area image, as illustrated in FIG. 6B. FIG. 6B illustrates an image represented by the predetermined-area information (x, y, a), which is set by default.

Hereinafter, a description is given of a relation between the predetermined-area information and the predetermined-area image with reference to FIG. 7. As illustrated in FIG. 7, a center point CP of 2L provides the parameters (x, y) of the predetermined-area information, where 2L denotes a diagonal angle of view of the predetermined area T. Distance f denotes a distance from the virtual camera IC to the central point CP. In FIG. 7, a trigonometric function equation generally expressed by the following equation is satisfied.

Lf=tan(α/2)

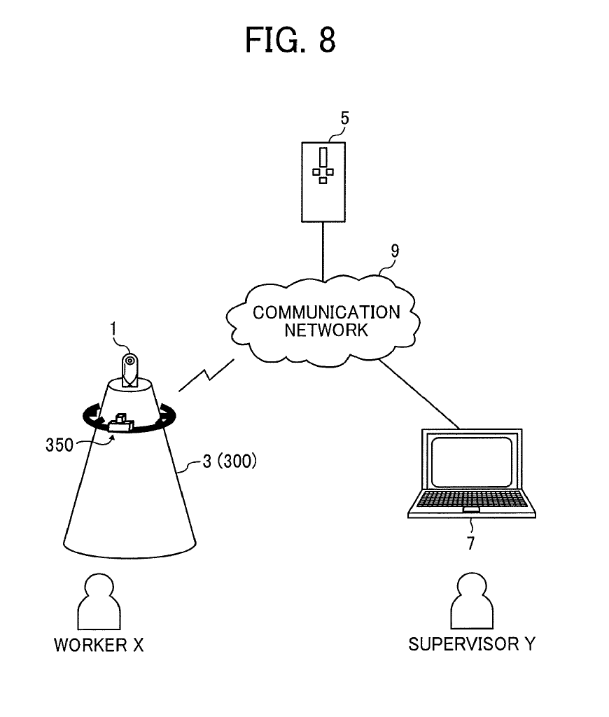

Hereinafter, a description is given of an overview of a configuration of an image communication system according to this embodiment with reference to FIG. 8.

As illustrated in FIG. 8, the image communication system includes the image capturing device 1, a communication terminal 3, an image management system 5, and a communication terminal 7.

As described above, the image capturing device 1 is a digital camera capable of obtaining the full spherical panoramic image. Alternatively, the image capturing device 1 may be a typical digital camera. In a case where the communication terminal 3 includes a camera, the communication terminal 3 may also operate as the digital camera. In this embodiment, a description is given of a case where the image capturing device 1 is a digital camera that is capable of obtaining the full spherical panoramic image, in order to make the description simple. The communication terminal 3 operates at least as a docking station that charges the image capturing device 1 or exchanges data with the image capturing device 1. In this embodiment, the communication terminal 3 is implemented as a safety equipment such as a traffic cone that is placed at a construction site and the like. The communication terminal 3 communicates data with the image capturing device 1 via a contact. In addition, the communication terminal 3 communicates data with the image management system 5 via a communication network 9 by a wireless communication such as wireless fidelity (Wi-Fi). The communication network 9 is implemented by, for example, the Internet.

The image management system 5 communicates data with the communication terminal 3 and the communication terminal 7 via the communication network 9. The image management system 5 is implemented by, for example, a server computer. The image management system 5 is installed with OpenGL ES to generate the full spherical panoramic image. Further, the image management system 5 generates an image of a part of the full spherical panoramic image (the predetermined-area image or a specific-area image, which is described below) to provide the communication terminal 7 with thumbnail data and captured image data.

The communication terminal 7 communicates data with the image management system 5 via the communication network 9. The communication terminal 7 is implemented by, for example, a laptop computer. The image management system 5 may be implemented by either a single server computer or a plurality of server computers.

The image capturing device 1 and the communication terminal 3 are each placed at a desired position in each construction site such as an apartment house by a worker X. The communication terminal 3 could be more than one, each placed on each construction site. The communication terminal 7 is in, for example, a main office to allow one to remotely manage and monitor different construction sites. The communication terminal 7 displays an image transmitted via the image management system 5 to allow a supervisor Y view an image representing the situation of each site. The image representing the status of each site is hereinafter referred to as a “site status screen”. The image management system 5 is at, for example, a service enterprise to provide the communication terminal 7 with the captured image data transmitted from the communication terminals 3 at the different sites.

Hereinafter, a description is given of hardware configurations of the image capturing device 1, the communication terminal 3, the communication terminal 7, and the image management system 5 according to this embodiment with reference to FIGS. 9 to 14.

First, a description is given of a hardware configuration of the image capturing device 1 with reference to FIG. 9. Although a description is given of a case where the image capturing device 1 is an omnidirectional image capturing device having two image pickup devices, the image capturing device 1 may include three or more image pickup devices. In addition, the image capturing device 1 is not necessarily an image capturing device 1 dedicated to omnidirectional image capturing. Alternatively, an external omnidirectional image capturing unit may be attached to a general digital camera or a smartphone to implement an image capturing device having the substantially same function as that of the image capturing device 1.

As illustrated in FIG. 9, the image capturing device 1 includes an imaging unit 101, an image processor 104, an imaging controller 105, a microphone 108, a sound processor 109, a central processing unit (CPU) 111, a read only memory (ROM) 112, a static random access memory (SRAM) 113, a dynamic random access memory (DRAM) 114, an operation unit 115, a network interface (I/F) 116, a communication unit 117, an electronic compass 118, and an antenna 117a.

The imaging unit 101 includes two wide-angle lenses (so-called fish-eye lenses) 102a and 102b, each having an angle of view of equal to or greater than 180 degrees so as to form a hemispheric image. The imaging unit 101 further includes the two image pickup device 103a and 103b corresponding to the wide-angle lenses 102a and 102b respectively. The image pickup devices 103a and 103b each includes an image sensor such as a complementary metal oxide semiconductor (CMOS) sensor and a charge-coupled device (CCD) sensor, a timing generation circuit, and a group of registers. The image sensor converts an optical image formed by the wide-angle lenses 102a and 102b into electric signals to output image data. The timing generation circuit generates horizontal or vertical synchronization signals, pixel clocks and the like for the image sensor. Various commands, parameters and the like for operations of the image pickup devices 103a and 103b are set in the group of registers.

Each of the image pickup devices 103a and 103b of the imaging unit 101 is connected to the image processor 104 via a parallel I/F bus. In addition, each of the image pickup device 103a and 103b of the imaging unit 101 is connected to the imaging controller 105 via a serial I/F bus such as an I2C bus. The image processor 104 and the imaging controller 105 are each connected to the CPU 111 via a bus 110. Furthermore, the ROM 112, the SRAM 113, the DRAM 114, the operation unit 115, the network I/F 116, the communication unit 117, and the electronic compass 118 are also connected to the bus 110.

The image processor 104 acquires the image data from each of the image pickup devices 103a and 103b via the parallel I/F bus and performs predetermined processing on each acquired image data. Thereafter, the image processor 104 combines these image data, on which the predetermined processing is performed, to generate data of the Mercator image illustrated in FIG. 3C.

The imaging controller 105 sets commands and the like in the group of registers of the image pickup devices 103a and 103b via the I2C bus, while the imaging controller 105 usually operates as a master device and the image pickup devices 103a and 103b each usually operates as a slave device. The imaging controller 105 receives necessary commands and the like from the CPU 111. Further, the imaging controller 105 acquires status data and the like from the group of registers of the image pickup devices 103a and 103b via the I2C bus to send the acquired status data and the like to the CPU 111.

Furthermore, the imaging controller 105 instructs the image pickup devices 103a and 103b to output the image data at a time when the shutter button of the operation unit 115 is pushed. The image capturing device 1 may have a preview function or support displaying movie. In this case, the image data are continuously output from the image pickup devices 103a and 103b at a predetermined frame rate (frames per minute).

Furthermore, the imaging controller 105 as an example of a synchronization unit operates with the CPU 111 to synchronize times when the image pickup devices 103a and 103b output the image data. The image capturing device 1 according to this embodiment does not include a display. However, the image capturing device 1 may include the display.

The microphone 108 converts sounds to audio data (signal). The sound processor 109 acquires the audio data from the microphone 108 via an I/F bus and performs predetermined processing on the audio data.

The CPU 111 controls entire operation of the image capturing device 1 and performs necessary processing. The ROM 112 stores various programs for the CPU 111. The SRAM 113 and the DRAM 114 each operates as a work memory to store the program loaded from the ROM 112 for execution by the CPU 111 or data in current processing. More specifically, the DRAM 114 stores the image data currently processed by the image processor 104 and the data of the Mercator image on which processing has been performed.

The operation unit 115 collectively refers to various operation keys, a power switch, the shutter button, and a touch panel having functions of both displaying information and receiving input from a user. The user operates the operation keys to instruct specifying various photographing modes or photographing conditions.

The network I/F 116 collectively refers to an interface circuit such as an universal serial bus (USB) I/F that allows the image capturing device 1 to communicate data with an external media such as a SD card or an external personal computer. The network I/F 116 supports at least one of wired and wireless communications. The data of the Mercator image, which is stored in the DRAM 114, is stored in the external media via the network I/F 116 or transmitted to the external device such as the communication terminal 3 via the network I/F 116.

The communication unit 117, which is implemented by, for example, an interface circuit, communicates data with an external device such as the communication terminal 3 via the antenna 117a by a near distance wireless communication such as Wi-Fi and Near Field Communication (NFC). The communication unit 117 is also capable of transmitting the data of Mercator image to the external device such as the communication terminal 3.

The electronic compass 118 calculates an orientation and a tilt (roll angle) of the image capturing device 1 from the Earth's magnetism to output orientation and tilt information. This orientation and tilt information is an example of related information, which is meta data described in compliance with Exif. This information is used for image processing such as image correction of the captured image. Further, the related information also includes a date and time when the image is captured by the image capturing device 1, and a size of the image data.

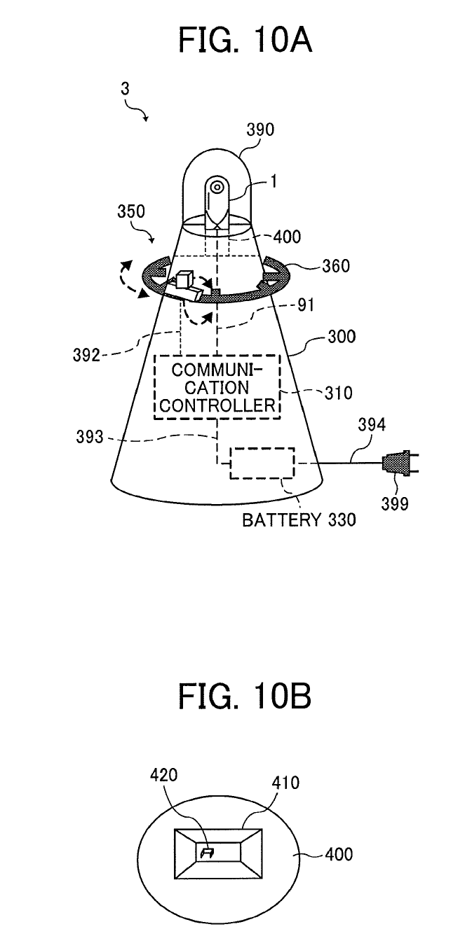

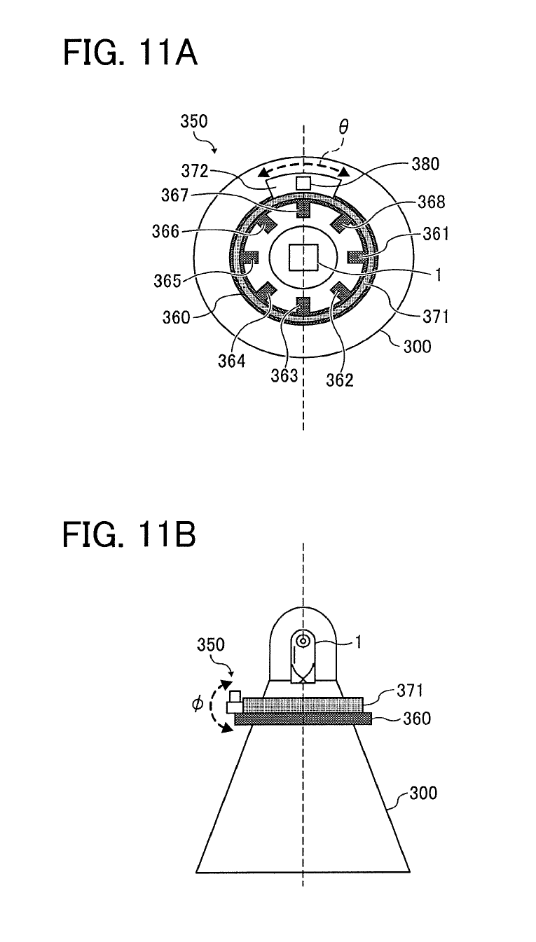

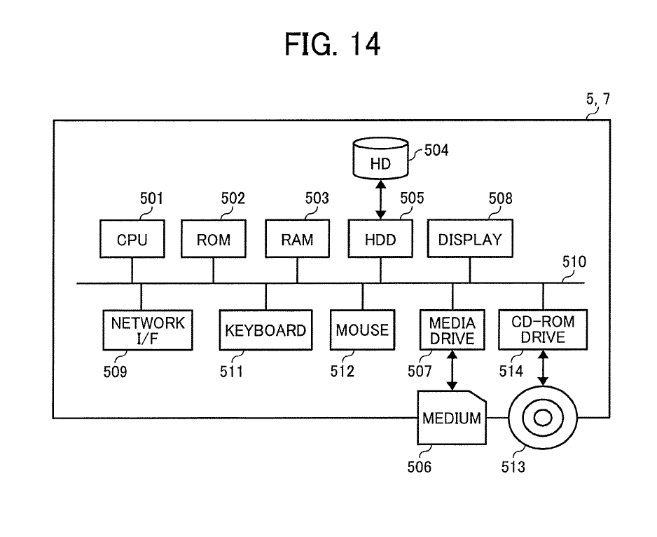

Hereinafter, a description is given of a hardware configuration of the communication terminal 3 with reference to FIGS. 10A and 10B and FIG. 14. FIG. 10A is a perspective view of the communication terminal 3, to which the image capturing device 1 is mounted. FIG. 10B is a perspective view of a mounting part 400 of the communication terminal 3. FIGS. 11A and 11B are respectively a plan view and a side view of the communication terminal 3.

As illustrated in FIG. 10A, the communication terminal 3 includes a traffic cone 300, an irradiation position control unit 350, and a cover 390. The traffic cone 300 is a traffic cone having a hollow portion inside thereof and being made of plastic, which is usually used in construction sites and the like. The communication terminal 3 further includes a communication controller 310 and a battery 330 in the hollow portion inside the traffic cone 300. The communication controller 310 transmits data acquired from the image capturing device 1 to the image management system 5 via the communication network 9. The battery 330 as a secondary battery supplies power in case of power failure. The battery 330 is charged by power supplied from an outlet to which a plug 399 is connected. The communication terminal 3 further includes the mounting part 400 on the top of the traffic cone 300.

As illustrated in FIG. 10B, the mounting part 400 has an opening 410, which is a recess to which the image capturing device 1 is detachably mounted. The mounting part 400 also has, on the bottom of opening 410, a USB connection I/F 420 having a convex shape. The image capturing device 1 has, on the bottom thereof, the USB connection I/F having a concave shape. The USB connection I/F 420 of the mounting part 400 and the USB connection I/F of the image capturing device 1 are detachably connected to each other. The image capturing device 1 is mounted to the communication terminal 3 such that the image pickup device 103a of the image capturing device 1 always faces in a specific direction relative to the communication terminal 3. The cover 390 is transparent and made of plastic or glass to protect the image capturing device 1. A micro USB connection I/F may be used as the USB connection I/F 420 and the USB connection I/F of the image capturing device.

The mounting part 400 and the communication controller 310 are connected to each other via a cable 391. The cable 391 is used for data exchange between the mounting part 400 and the communication controller 310 or supplying power. The irradiation position control unit 350 and the communication controller 310 are connected to each other via a cable 392. The cable 392 is used for data exchange between the irradiation position control unit 350 and the communication controller 310 or supplying power. The communication controller 310 and the battery 330 are connected to each other via a cable 393. The cable 393 is used for supplying power from the battery 330 to the communication controller 310. The battery 330 and the plug 399 are connected to each other via a power supply cable 394.

As illustrated in FIGS. 11A and 11B, the irradiation position control unit 350 includes a guide rail 360, support rods 361 to 368, a support table 372, and an irradiation device 380. The guide rail 360 is a rail along which the support table 372 turns in a θ-direction. The support rods 361 to 368 support the traffic cone 300 provided with the guide rail 360. The irradiation device 380 is mounted on the support table 372. The support table 372 moves in the θ-direction along the guide rail 360, which in turn moves the irradiation device 380 in the θ-direction.

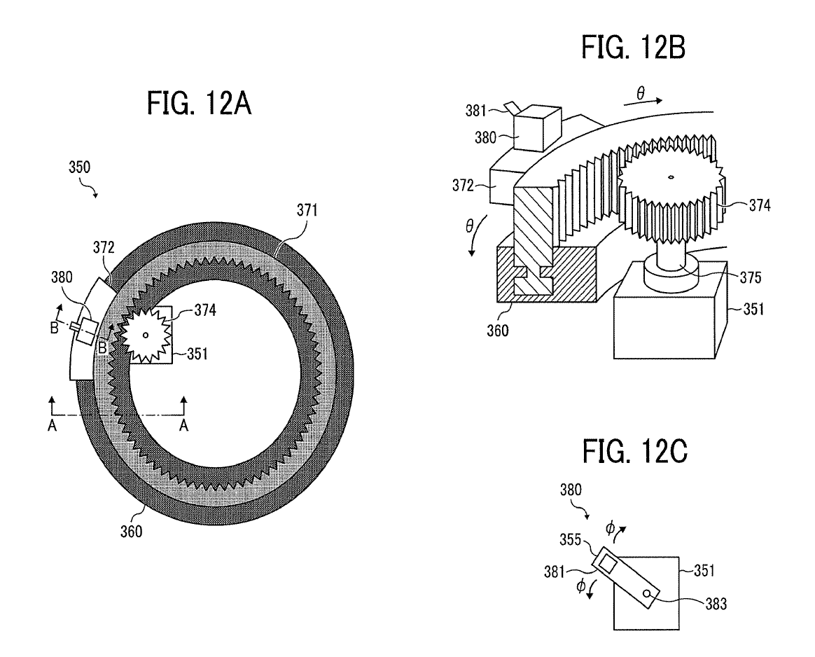

Hereinafter, a description is given of a mechanism of the irradiation position control unit 350 with reference to FIGS. 12A and 12B. FIG. 12A is a plan view of the irradiation position control unit 350. FIG. 12B is a cross-sectional view of the irradiation position control unit 350 taken through line A-A of FIG. 12A. FIG. 12C is a cross-sectional view of the irradiation position control unit 350 taken through line B-B of FIG. 12A.

As illustrated in FIGS. 12A and 12B, the irradiation position control unit 350 includes a motor 351, the guide rail 360, a rotation table 371, the support table 372, a spur gear 374, and the irradiation device 380.

The motor 351 is a servomotor to rotate a rotation shaft 375, which in turn rotates the spur gear 374. The rotation table 371 having a ring shape is rotatably provided on the guide rail 360. The rotation table 371 has an internal gear that engages with the spur gear 374. The motor 351 drives and rotates the spur gear 374, which in turn moves the rotation table 371 in the θ-direction relative to the guide rail 360. This movement of the rotation table 371 causes the support table 372 mounted to the rotation table 371 to move in the θ-direction. Accordingly, the irradiation device 380 on the support table 372 also moves in the θ-direction.

Further, as illustrated in FIG. 12C, a pointer 381 and a motor 353 are provided inside the irradiation device 380. A light emitting diode (LED) 355 is provided at a tip portion of the pointer 381. The motor 353 is a servomotor to rotate a rotation shaft 383, which in turn rotate the pointer 381 in a φ-direction. With the configuration as described above, the irradiation position control unit 350 allows the irradiation device 380 to irradiate, with laser light, a substantially entire area of objects surrounding the image capturing device 1 for the full spherical panoramic photographing.

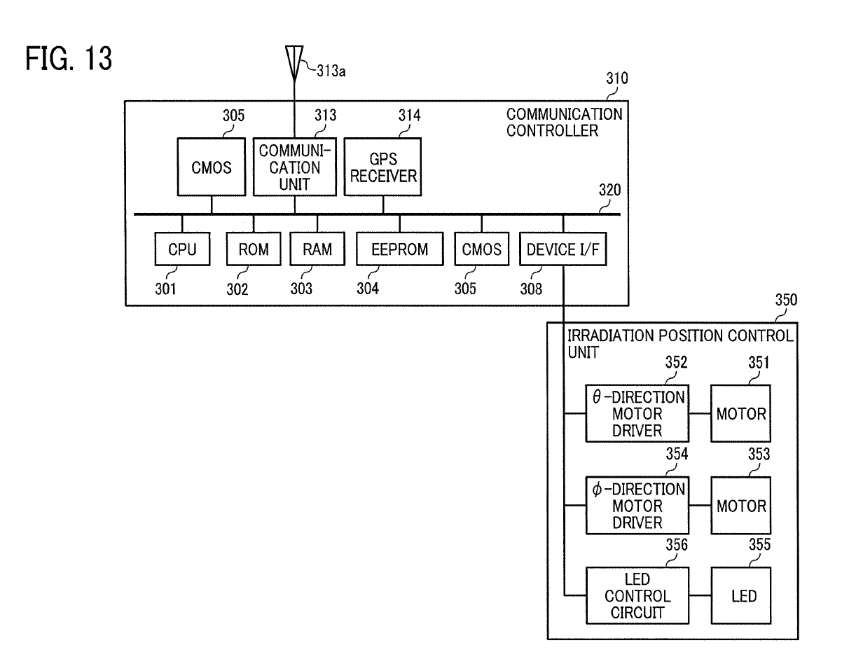

Hereinafter, a description is given of an electrical hardware configuration of the communication terminal 3 with reference to FIG. 13.

As illustrated in FIG. 13, the communication terminal 3 includes the communication controller 310 and the irradiation position control unit 350. The communication controller 310 includes a CPU 301, a ROM 302, a RAM 303, an electrically erasable programmable ROM (EEPROM) 304, a CMOS sensor 305, and a device I/F 308. The CPU 301 controls entire operation of the communication terminal 3. The ROM 302 stores basic input/output programs. The CPU 301 uses the RAM 302 as a work area when executing programs or processing data. The EEPROM 304 performs data reading and writing under control of the CPU 301. The CMOS sensor 305 is an image pickup device that captures an image of an object to obtain image data under control of the CPU 301. The device I/F 308 electrically connects the communication controller 310 to other devices. When the image capturing device 1 is mounted to the communication terminal 3 as illustrated in FIG. 10, the image capturing device 1 and the communication terminal 3 are electrically connected to each other via the device I/F 308.

The EEPROM 304 stores an operating system (OS) for execution by the CPU 301, other programs, and various data. Instead of the CMOS sensor 305, a CCD sensor may be used.

Further, the communication terminal 3 includes an antenna 313a, a communication unit 313, a global positioning systems (GPS) receiver 314, and a bus line 320. The communication unit 313, which is implemented by, for example, an interface circuit, communicates data with other apparatuses or terminals by wireless communication signals using the antenna 313a. The GPS receiver 314 receives GPS signals containing a position information of the communication terminal 3 with GPS satellites or an indoor Messaging system as indoor GPS. This position information of communication terminal 3 is represented by, for example, a latitude, longitude, and altitude. The bus line 320 electrically connects those parts or devices of the communication terminal 3 to each other. Examples of the bus line 320 include an address bus and a data bus. The irradiation position control unit 350 is electrically connected to the device I/F 308. The irradiation position control unit 350 includes the motor 351 illustrated FIG. 12B and a motor driver 352. The motor 351 causes the irradiation device 380 to move in the θ-direction along the guide rail 360 as illustrated in FIG. 11A. The motor driver 352 controls driving of the motor 351. The irradiation position control unit 350 includes the motor 353 illustrated in FIG. 12C and a motor driver 354. The motor 353 cause the pointer 381 of the irradiation device 380 to rotate in the φ-direction at a specific position on the guide rail 360 as illustrated in FIG. 11B. The motor driver 354 controls driving of the motor 353. Furthermore, the irradiation position control unit 350 includes the LED 355 and an LED control circuit 356. The LED 355 emits laser light. The LED control circuit controls turning on-and-off of the LED 355. The CPU 301 of the communication controller 310 controls an operation and processing of the motor driver 352, the motor driver 354, and the LED control circuit 356 of the irradiation position control unit 350.

Hereinafter, a description is given of hardware configurations of the image management system 5 and the communication terminal 7, which is implemented by a laptop computer in this embodiment, with reference to FIG. 14. In this embodiment, both the image management system 5 and the communication terminal 7 are implemented by a computer. Therefore, a description is given of a configuration of the image management system 5, and the description of a configuration of the communication terminal 7 is omitted, having the same or substantially same configuration as that of the image management system 5.

The image management system 5 includes a CPU 501, a ROM 502, a RAM 503, an HD 504, a hard disc drive (HDD) 505, a media drive 507, a display 508, a network I/F 509, a keyboard 511, a mouse 512, a compact-disc read only memory (CD-ROM) drive 514, and a bus line 510. The CPU 501 controls entire operation of the image management system 5. The ROM 502 stores programs such as an initial program loader to boot the CPU 501. The CPU 501 uses the RAM 503 as a work area when executing programs or processing data. The HD 504 stores various data such as programs for the image management system 5. The HDD 505 controls reading and writing of data from and to the HD 504 under control of the CPU 501. The media drive 507 controls reading and writing (storing) of data from and to a recording medium 506 such as a flash memory. The display 508 displays various information such as a cursor, menus, windows, characters, or images. The network I/F 509 communicates data with another apparatus such as the communication terminal 3 and the communication terminal 7 via the communication network 9. The keyboard 511 includes a plurality of keys to allow a user to input characters, numbers, and various instructions. The mouse 512 allows a user to input an instruction for selecting and executing various functions, selecting an item to be processed, or moving the cursor. The CD-ROM drive 514 controls reading and writing of data from and to a CD-ROM 513 as an example of a removable recording medium. The bus line 510 electrically connects those parts or devices of the image management system 5 to each other as illustrated in FIG. 14. Examples of the bus line 510 include an address bus and a data bus.

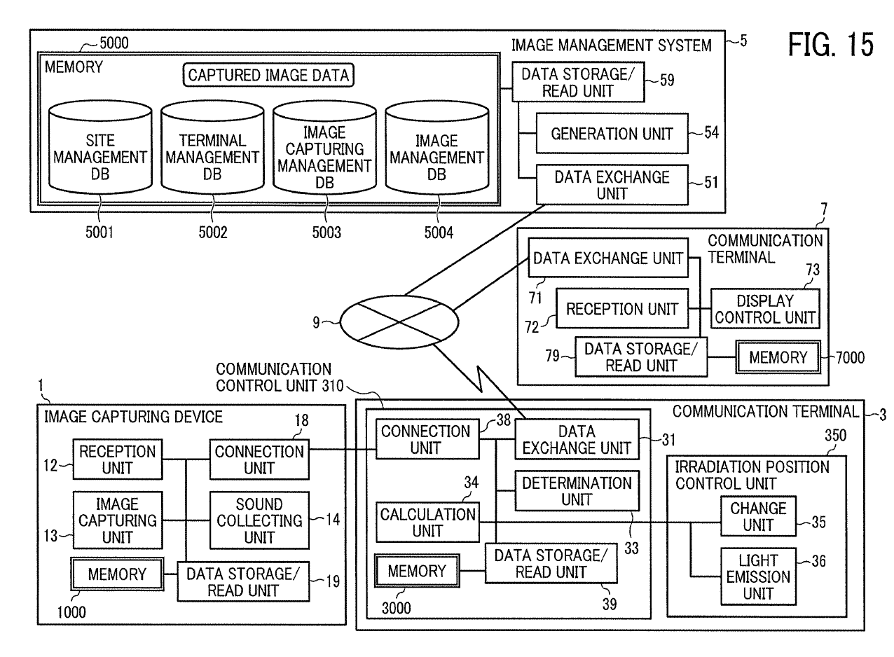

Hereinafter, a description is given of a functional configuration of the image communication system according to this embodiment. FIG. 15 is a block diagram illustrating functional configurations of the image capturing device 1, the communication terminal 3, and the image management system 5, and the communication terminal 7, which constitute a part of the image communication system according this embodiment. In the image communication system illustrated in FIG. 15, the image management system 5 communicates data with the communication terminal 3 and communication terminal 7 via the communication network 9.

As illustrated in FIG. 15, the image capturing device 1 includes a reception unit 12, an image capturing unit 13, a sound collecting unit 14, a connection unit 18, and a data storage/read unit 19. These functional blocks 12 to 19 are implemented by one or more hardware components illustrated in FIG. 9, when operating in accordance with instructions from the CPU 111 executing according to the program for the image capturing device 1, loaded onto the DRAM 114 from the SRAM 113.

The image capturing device 1 further includes a memory 1000, which is implemented by the ROM 112, the SRAM 113, or the DRAM 114.

Hereinafter, a description is given of details of these functional blocks 12 to 19 of the image capturing device 1 with reference to FIGS. 9 and 15.

The reception unit 12 of the image capturing device 1 is implemented by the operation unit 115 and the CPU 111, which operate in cooperation with each other, to receive an instruction input from the operation unit 115 according to by a user (the worker X) operation.

The image capturing unit 13 is implemented by the imaging unit 101, the image processor 104, the imaging controller 105, and the CPU 111, which operate in cooperation with each other, to capture an image of the surroundings and acquire captured image data.

The sound collecting unit 14 is implement by the microphone 108 and the sound collecting unit 14, when operating under control of the CPU 111, to collect sounds around the image capturing device 1.

The connection unit 18 is implement by the USB connection I/F having a concave shape provided on the bottom of the image capturing device 1, when operating under control of the CPU 111, to receive power supplied from the communication terminal 3 and communicate data with the communication terminal 3.

The data storage/read unit 19 is implement by the CPU 111, when executing according to the program loaded onto the DRAM 114, to store data or information in the memory 1000 and read out data or information from the memory 1000.

As illustrated in FIG. 15, the communication terminal 3 includes the communication controller 310 and the irradiation position control unit 350. The communication controller 310 includes a data exchange unit 31, a determination unit 33, a calculation unit 34, a connection unit 38, and data storage/read unit 39. These functional blocks 31 to 39 are implemented by one or more hardware components illustrated in FIG. 13, when operating in accordance with instructions from the CPU 301 executing according to the programs for the communication terminal 3, loaded onto the RAM 303 from the EEPROM 304.

The communication terminal 3 further includes a memory 3000, which is implemented by the ROM 302, the RAM 303, and the EEPROM 304 illustrated in FIG. 13.

The irradiation position control unit 350 includes a change unit 35 and a light emission unit 36. These functional blocks 31 to 39 are implemented by one or more hardware components illustrated in FIG. 13, when operating in accordance with instructions from the CPU 301 executing according to the programs for the communication terminal 3, loaded onto the RAM 303 from the EEPROM 304.

Hereinafter, a description is given of details of these functional blocks 31 to 39 with reference to FIGS. 13 and 15.

The data exchange unit 31 of the communication controller 310 is implemented by the communication unit 313 illustrated in FIG. 13, when operating under control of the CPU 301, to exchange data with the image management system 5 via the communication network 9. The data exchange unit 31 is an example of a transmitter to transmit data of the full spherical panoramic image and a receiver to receive position coordinate information described below.

The determination unit 33 is implemented by the CPU 301 when executing according to the program loaded onto the RAM 303, to determine a distance between a designation position designated by a cursor 4 and an irradiation position irradiated by the LED 355 is within a threshold, for example, 10 centimeter in the real space.

The calculation unit 34 is implemented by the CPU 301 when executing according to the program loaded onto the RAM 303. The calculation unit 34 transforms a coordinate system of the full spherical panoramic image in the image capturing device 1 to a coordinate system of a space of the site where the communication terminal 3 is positioned, to calculate, from the designation position in the full spherical panoramic image, an irradiation position irradiated with laser light in the space of the site.

The connection unit 38 is implement by the USB connection I/F 420, when operating under control of the CPU 111, to supply power to the communication terminal 3 and communicate data with the communication terminal 3. While the connection unit 18 is an example of a provision unit to provide the full spherical panoramic image data, the connection unit 38 is an example of an acquisition unit to acquire the full spherical panoramic image.

The data storage/read unit 39 is implement by the CPU 301, when executing according to the program loaded onto the RAM 303, to store data or information in the memory 3000 and read out data or information from the memory 3000.

The change unit 35 of the irradiation position control unit 350 is implemented by the motor driver 352, the motor driver 354, the motor 351, and the motor 353 illustrated in FIG. 13, when operating under control of the CPU 301. The change unit 35 controls changing of the movement of the irradiation device 380 in the θ-direction and the movement of the pointer 381 in the φ-direction. The light emission unit 36 is implemented by the irradiation position control unit 350 illustrated in FIGS. 12A to 12C and the LED control circuit 356 and the LED 355 illustrated in FIG. 13, when operating under control of the CPU 301. The light emission unit 36 causes the irradiation device 380 to emit laser light and controls the light emission.

Hereinafter, a description is given of a functional configuration of the image management system 5 with reference to FIGS. 14 and 15. The image management system 5 includes a data exchange unit 51, a generation unit 54, and data storage/read unit 59. These functional blocks 51, 54, and 59 are implemented by one or more hardware components illustrated in FIG. 13, when operating in accordance with instructions from the CPU 501 executing according to the programs for the image management system 5, loaded onto the RAM 503 from the HD 504.

The image management system 5 further includes a memory 5000, which is implemented by the RAM 503 and the HD 504 illustrated in FIG. 14. The memory 5000 includes a site management database (DB) 5001, a terminal management DB 5002, an image capturing management DB 5003, and an image management DB 5004. A site management table, which is described below, constitutes the site management DB 5001. A terminal management table, which is described below, constitutes the terminal management DB 5002. An image capturing management table, which is described below, constitutes the image capturing management DB 5003. An image management table, which is described below, constitutes the image management DB 5004.

FIG. 16 is a view illustrating an example of the site management table. The site management table stores an area ID, an area name, a site name, a file name of a site layout map, and a device ID in association with one another. The area ID is an example of area identification information for identifying an area. The area indicates a certain domain such as Tokyo, Shibuya-ku, New York State, and New York City. The site ID is an example of site identification information for identifying a site. The site name indicates a construction site and the like. The site layout map represents, as illustrated in FIG. 20, a layout of each site. In the layout map, a position in the site is specified in detail by two-dimensional coordinate. FIG. 20 is a view illustrating an example of the site layout map. Specifically, FIG. 20 illustrates a layout map of an apartment house as a construction site. The device ID is an example of device identification information for identifying the image capturing device 1. Data of the layout maps of different sites are stored in the memory 5000.

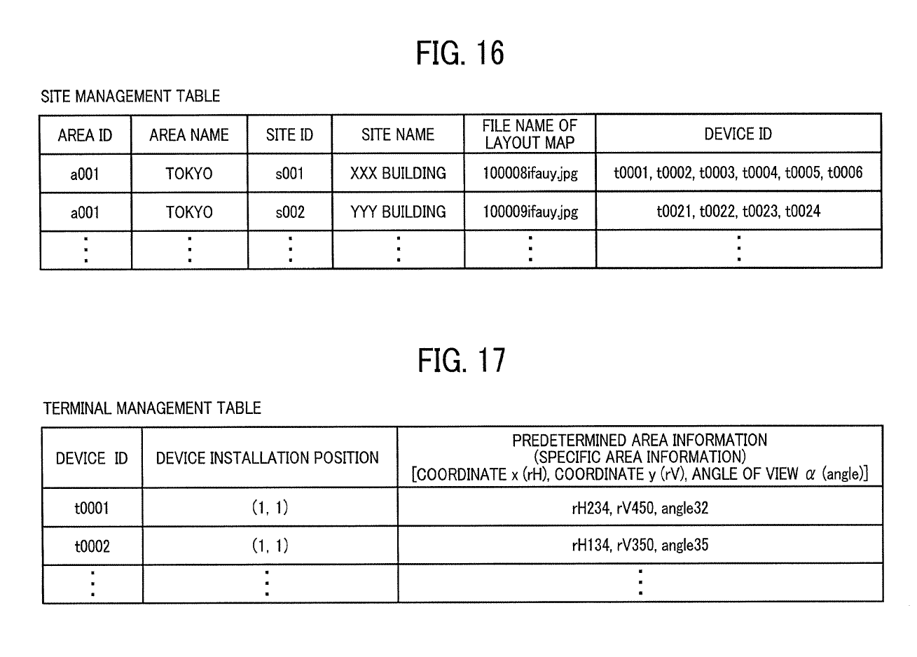

FIG. 17 is a view illustrating an example of the terminal management table. The terminal management table stores device installation position information and the predetermined-area information in association with each device ID. The device installation position information indicates a position at which the image capturing device 1 is placed on the layout map represented by two-dimensional coordinate as illustrated in FIG. 20. The predetermined-area information stored in the terminal management table is the predetermined-area information as described above with reference to FIG. 7. The supervisor Y obtains the device ID, the device installation position information, and the predetermined-area information in advance from the worker X. The worker X sends a notice to the supervisor Y by email and the like when the worker X places each image capturing device 1 at a specific position in the site.

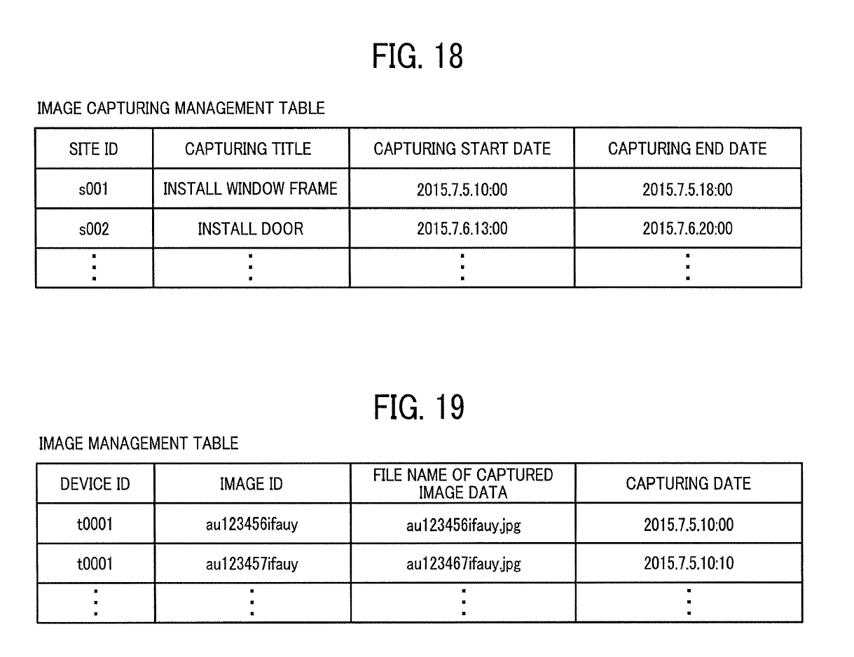

FIG. 18 is a view illustrating an example of the image capturing management table. The image capturing management table stores a capturing title, a capturing start date and time, a capturing end date and time in association with each device ID. The capturing title is a title input by the supervisor Y as viewer. The supervisor uses the capturing title to extract a desired captured image data from among a plurality of captured image data. The capturing start date and time is input by the supervisor Y. The capturing start date and time indicates a date and time at which the image capturing device 1 starts (or started) image capturing. The capturing end date and time is input by the supervisor Y. The capturing end date and time indicates a date and time at which the image capturing device 1 stops (or stopped) image capturing.

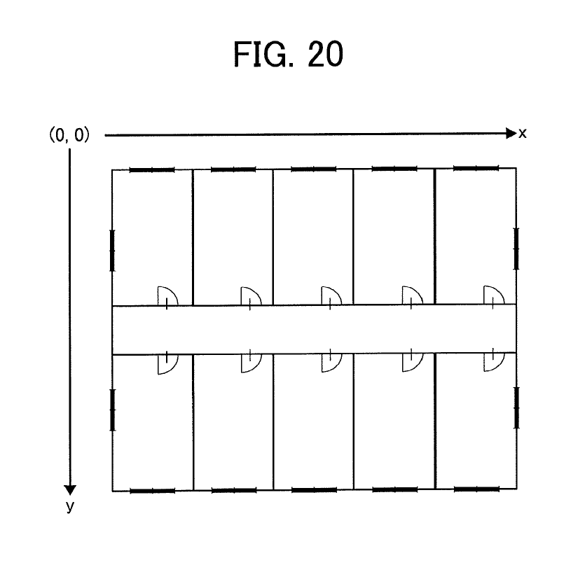

FIG. 19 is a view illustrating an example of the image management table. The image management table stores and manages an image ID, a file name of captured image data, and a capturing date and time in association with each device ID. The image ID is an example of image identification information for identifying a captured image data. The file name of captured image data indicates a file name of the captured image data associated with the image ID. The capturing date and time indicates a date and time at which the associated captured image data is captured by the image capturing device 1 identified by the device ID. The captured image data are stored in the memory 5000.

Hereinafter, a description is given of details of the functional blocks 51, 54 and 59 with reference to FIGS. 14 and 15.

The data exchange unit 51 of the image management system 5 is implemented by the network I/F 509 illustrated in FIG. 14, when operating under control of the CPU 501. The data exchange unit 51 exchanges data or information with the communication terminal 3 or communication terminal 7 via the communication network 9.

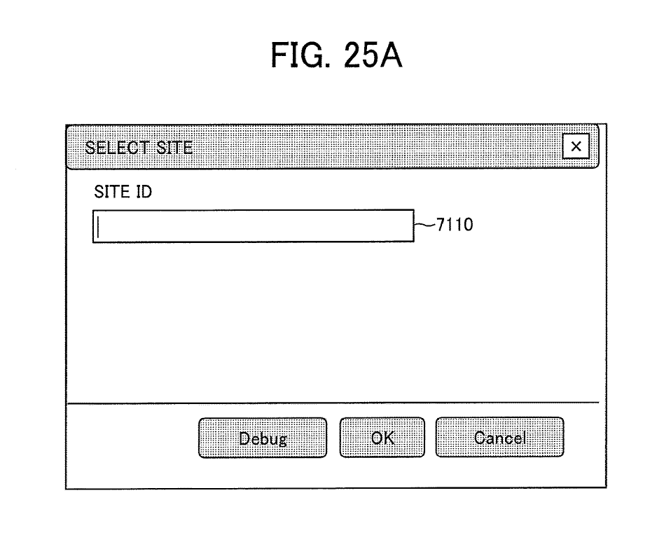

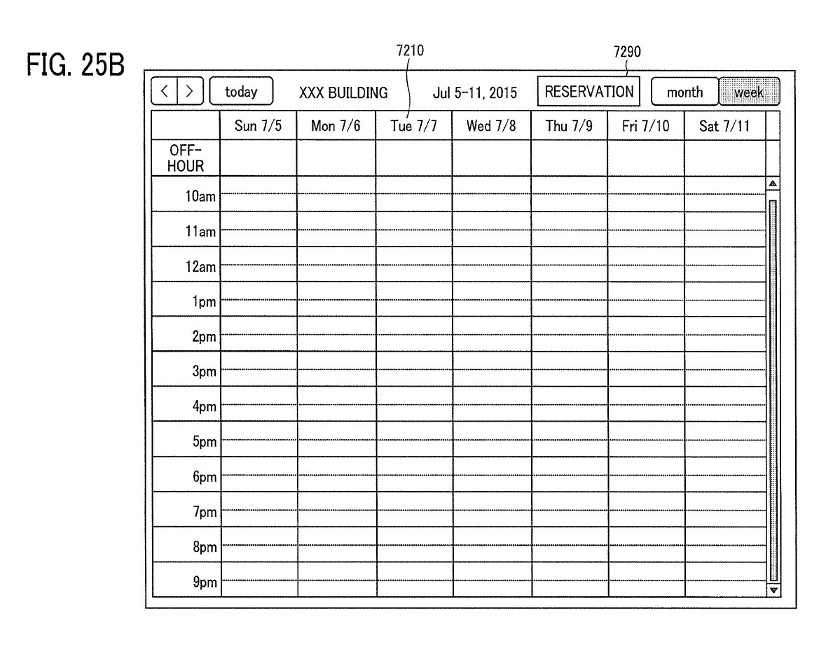

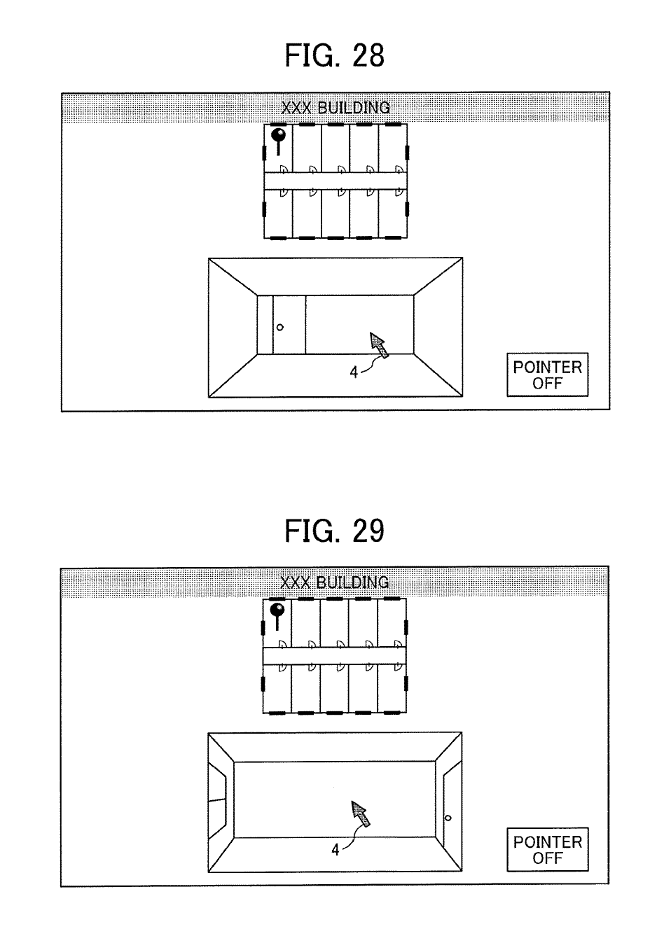

The generation unit 54 generates the site status screen as illustrated in FIGS. 25A and 25B to FIG. 31, which represents the status of a specific site.

The data storage/read unit 59 is implement by the HDD 505, when operating under control of the CPU 501, to store data or information in the memory 5000 and read out data or information from the memory 5000.

Hereinafter, a description is given of a functional configuration of the communication terminal 7 with reference to FIGS. 14 and 15. The communication terminal 7 includes a data exchange unit 71, a reception unit 72, a display controller 73, and a data storage/read unit 79. These functional blocks 71, 72, 73 and 79 are implemented by one or more hardware components illustrated in FIG. 14, when operating in accordance with instructions from the CPU 501 executing according to the programs for the communication terminal 7, loaded onto the RAM 503 from the HD 504.

The communication terminal 7 further includes a memory 7000, which is implemented by the RAM 503 and the HD 504 illustrated in FIG. 14.

Hereinafter, a description is given of details of these functional blocks 71, 72, 73 and 79 with reference to FIG. 15.

The data exchange unit 71 of the communication terminal 7 is implemented by the network I/F 509 illustrated in FIG. 14, when operating under control of the CPU 501. The data exchange unit 51 exchanges data or information with image management system 5 via the communication network 9.

The reception unit 72 is implement by the keyboard 511 and the mouse 512, when operating under control of the CPU 111, to receive an instruction from a user, e.g., the supervisor Y in FIG. 8.

The display controller 73 is implemented by the CPU 501 illustrated in FIG. 14, when executing according to the program loaded onto the RAM 503, to control the display 508 of the communication terminal 7 to display images.

The data storage/read unit 79 is implement by the HDD 505, when operating under control of the CPU 501, to store data or information in the memory 7000 and read out data or information from the memory 7000.

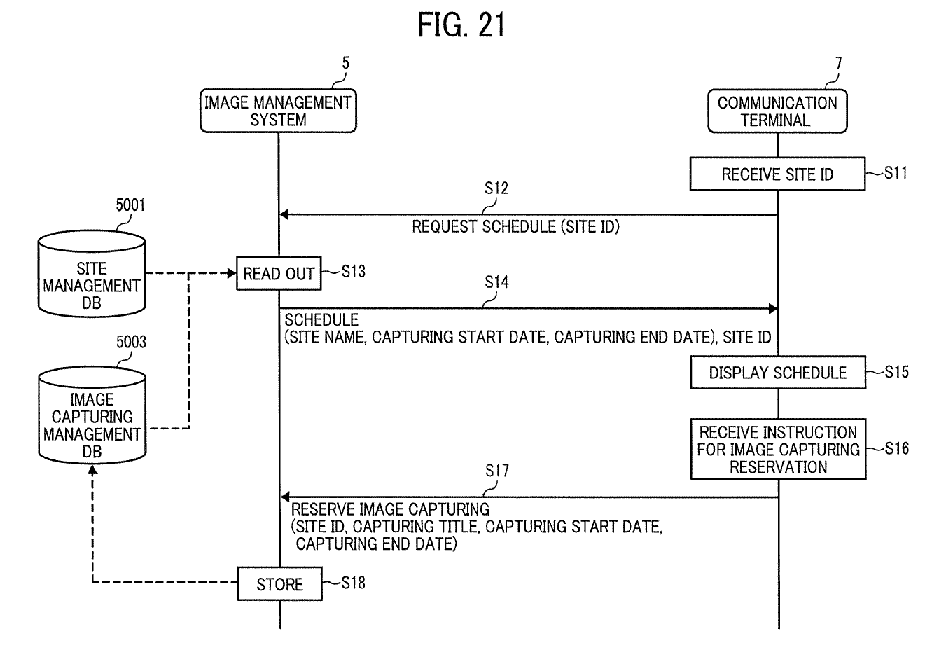

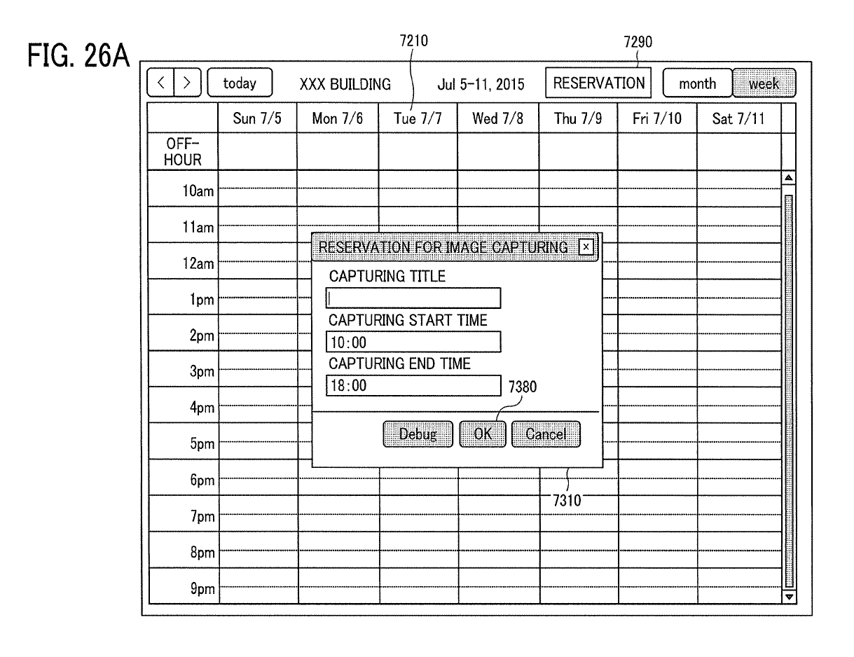

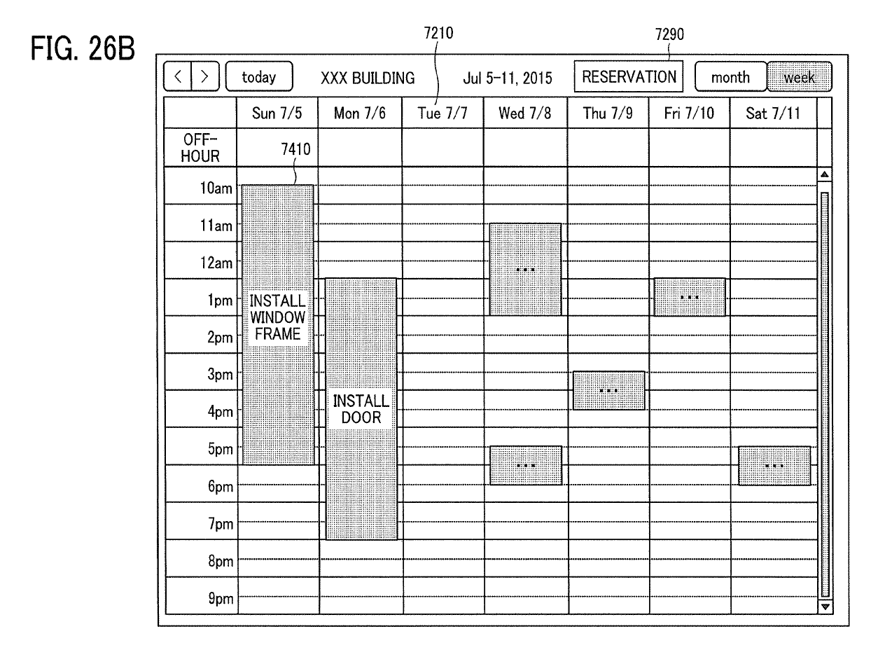

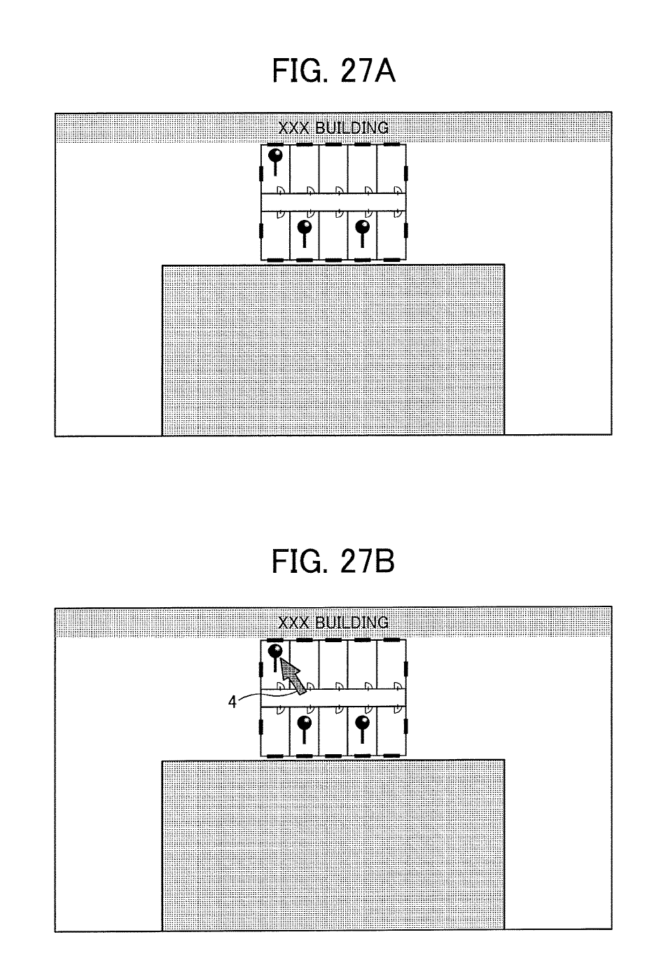

Hereinafter, a description is given of operations of making a reservation for image capturing, instructing image capturing, displaying the layout map, and displaying the image data, performed by the image communication system with reference to FIGS. 21 to 32. Hereinafter, a description is given of an operation of making a reservation for image capturing by the image capturing device 1, performed by the communication terminal 7 in accordance with an instruction from the supervisor Y. FIG. 21 is a sequence diagram illustrating an operation of making a reservation for image capturing. In addition, FIGS. 25A and 25B to FIG. 31 each illustrates an example of a screen displayed on the communication terminal 7 used by a supervisor. Specifically, FIGS. 25A and 25B and FIGS. 26A and 26B each illustrates a schedule screen. Further, FIGS. 27 to 31 each illustrates the site status screen, which represents the status of a specific site.

As illustrated in FIG. 21, when the supervisor Y enters the site ID by the keyboard 511 or the mouse 512 of the communication terminal 7, the reception unit 72 receives an instruction for specifying the site ID (S11). Specifically, as illustrated in FIG. 25A, a field 7110 for entering the site ID is displayed on the display 508 of the communication terminal 7. The supervisor Y enters, in the field 7110, the site ID corresponding to a site such as a construction site that the supervisor Y wants to view. In response to the instruction received by the reception unit 72, the data exchange unit 71 sends a request for a schedule to the image management system 5 (S12). This request includes the site ID received by the reception unit 72 at S11. Thus, the data exchange unit 51 of the image management system 5 receives the request for the schedule from the communication terminal 7.

Next, at S13, the data storage/read unit 59 of the image management system 5 searches the image capturing management table (see FIG. 18) with the site ID received by the data exchange unit 51 as a retrieval key to read out the capturing title, the capturing start date and time, and the capturing end date and time associated with the site ID. In addition, at S13, the data storage/read unit 59 searches the site management table (see FIG. 16) with the site ID as a retrieval key to read out the site name associated with the site ID. Thereafter, the generation unit 54 generates the schedule screen as illustrated in FIG. 25B based on those information read out at S13. The data exchange unit 51 transmits data of the schedule screen to the communication terminal 7 (S14). The data exchange unit 51 also transmits the site ID together with the data of the schedule screen. Thus, the data exchange unit 71 of the communication terminal 7 receives the data of the schedule screen.

The display controller 73 displays the schedule screen as illustrated in FIG. 25B on the display 508 of the communication terminal 7 (S15). The schedule screen displayed at S15 includes a time table for each day and a reservation key 290. The reception unit 72 receives an instruction for making a reservation for image capturing from the supervisor Y (S16). Specifically, when the supervisor Y selects an item 7210 of a desired date and thereafter selects the reservation key with the keyboard 511 or the mouse 512, the display controller 73 displays a “Reservation for Image Capturing” menu as illustrated FIG. 26A. When the supervisor Y enters the capturing title (“install window frame” in this example), a capturing start time (“10:00” in this example), and a capturing end time (“18:00” in this example), and thereafter selects a “OK” key 7380, the data exchange unit 71 sends a reservation for image capturing to the image management system 5 (S17). This reservation for image capturing includes the site ID, the capturing title, the capturing start date and time, and the capturing end date and time. Thus, the data exchange unit 51 of the image management system 5 receives the reservation for image capturing.

Next, the data storage/read unit 59 of the image management system 5 adds, to the image capturing management table (see FIG. 18), a new record indicating a content of the reservation for image capturing (S18). After S18, the operation of making a reservation for image capturing ends.

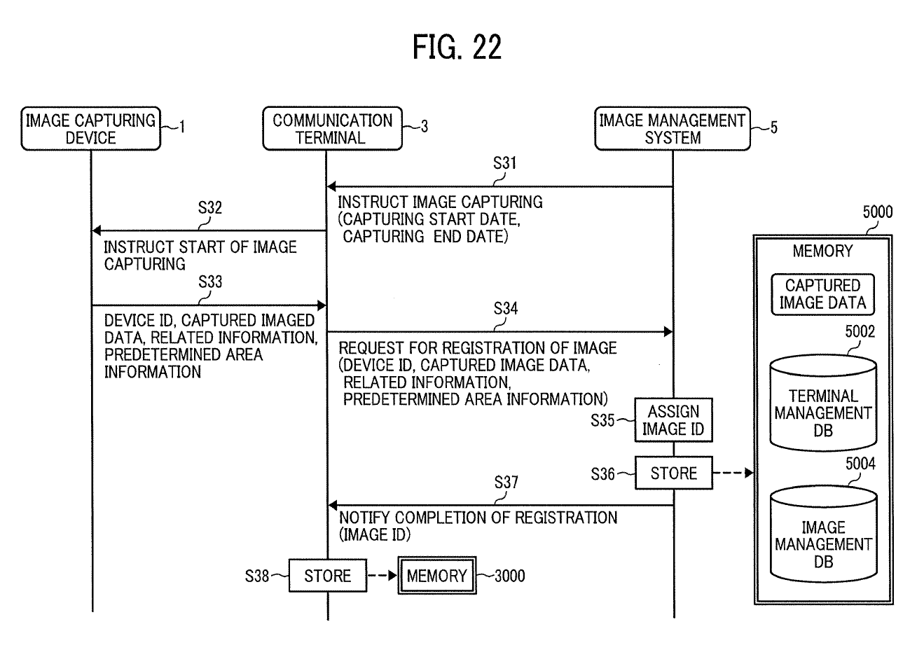

Hereinafter, a description is given of an operation of instructing the communication terminal 3 to capture an image, performed by the image management system 5 based on the image capturing management table (see FIG. 18). FIG. 22 is a sequence diagram illustrating an operation of instructing image capturing.

As illustrated in FIG. 22, the data exchange unit 51 of the image management system 5 sends an instruction for image capturing to every communication terminal 3 in the site represented by the site ID (S31). This instruction for image capturing includes the capturing start date and time, and the capturing end date and time. Thus, the communication terminal 3 receives the instruction for image capturing.

Next, at the capturing date and time included in the instruction transmitted from the image management system 5, the communication terminal 3 sends an instruction for starting image capturing to the image capturing device 1 (S32). Thus, the data exchange unit 11 of the image capturing device 1 receives the instruction for starting image capturing. Next, the image capturing device 1 performs image capturing every ten minute, for example, and sends its device ID, data of captured images (referred to as “captured image data” hereinafter), the related information, and the predetermined-area information to the communication terminal 3 (S33). The related information includes information on an actual capturing date and time, etc. The predetermined-area information includes information on a direction of a point of view that is preset before shipping. Thus, the data exchange unit 31 of the communication terminal 3 receives the device ID, the captured image data, the related information, and the predetermined-area information.

Next, the data exchange unit 31 of the communication terminal 3 sends, to the image management system 5, a request for image registration (S34). This request for image registration includes the device ID, the captured image data, the related information, and the predetermined-area information, which are sent from the image capturing device 1 to the image capturing device 1 at S33. Thus, the data exchange unit 51 of the image management system 5 receives the request for image registration. The data storage/read unit 59 of the image management system 5 assigns a new image ID to the captured image data received at S34 (S35).

Next, the data storage/read unit 59 stores these information in different tables for management (S36). Specifically, the data storage/read unit 59 overwrites the predetermined-area information corresponding to the device ID in the terminal management table (see FIG. 17). Further, the data storage/read unit 59 adds, to the image management table (see FIG. 19), a new record associating the device ID, the image ID, the file name of image data, and the capturing date and time with each other. The device ID that is added as the new record is the device ID received from the communication terminal 3 at S34. The image ID that is added as the new record is the image ID assigned at S35. The file name of image data that is added as the new record is the file name of the captured image data received from the communication terminal 3 at S34. The capturing date and time that is added as the new record is the capturing date and time included in the related information received from the communication terminal 3 at S34.

Next, the data exchange unit 51 sends, to the communication terminal 3, a notification indicating the image registration is completed (S37). This notification includes the image ID. Thus, the data exchange unit 31 of the communication terminal 3 receives the notification indicating that the image registration is completed. The data storage/read unit 39 of the communication terminal 3 stores the image ID in the memory 3000 (S38).

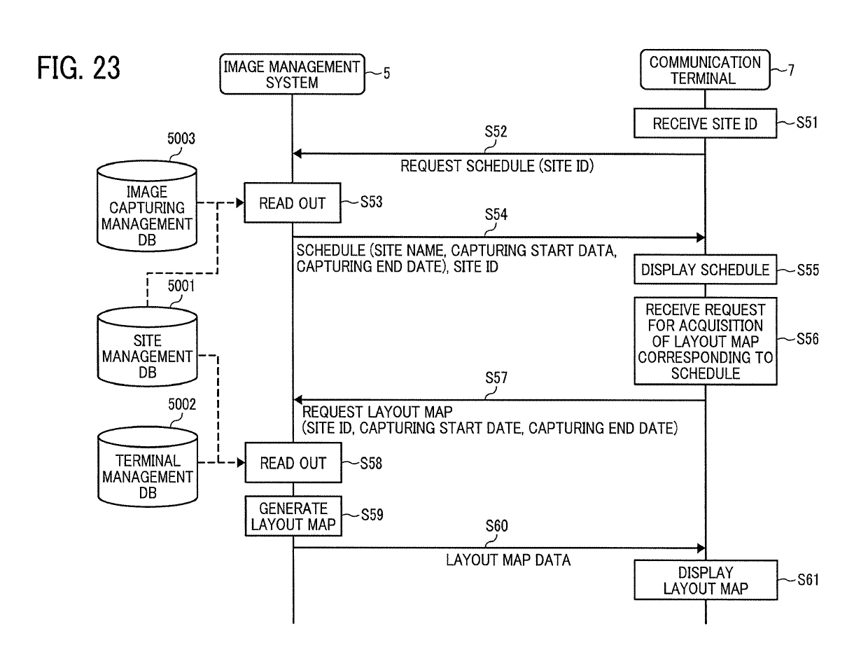

Hereinafter, a description is given of an operation of displaying the layout map with reference to FIG. 23. FIG. 23 is a sequence diagram illustrating an operation of displaying the layout map.

As illustrated in FIG. 23, when the supervisor Y enters the site ID by the keyboard 511 or the mouse 512 of the communication terminal 7, the reception unit 72 receives an instruction for specifying the site ID (S51). Specifically, as illustrated in FIG. 25A, the field 7110 for entering the site ID is displayed on the display 508 of the communication terminal 7. The supervisor Y enters, in the field 7110, the site ID corresponding to a site such as a construction site that the supervisor Y wants to view. In response to receiving the instruction by the reception unit 72, the data exchange unit 71 sends a request for the schedule to the image management system 5 (S52). This request includes the site ID received by the reception unit 72 at S51. Thus, the data exchange unit 51 of the image management system 5 receives the request for the schedule from the communication terminal 7.

Next, at S53, the data storage/read unit 59 of the image management system 5 searches the image capturing management table (see FIG. 18) with the site ID received by the data exchange unit 51 as a retrieval key to read out the capturing title, the capturing start date and time, and the capturing end date and time associated with the site ID. In addition, at S53, the data storage/read unit 59 searches the site management table (see FIG. 16) with the site ID as a retrieval key to read out the site name associated with the site ID. Thereafter, the generation unit 54 generates the schedule screen as illustrated in FIG. 26B based on those information read out at S53. The data exchange unit 51 transmits data of the schedule screen to the communication terminal 7 (S54). The data exchange unit 51 also transmits the site ID together with the data of the schedule screen. Thus, the data exchange unit 71 of the communication terminal 7 receives the data of the schedule screen.

The display controller 73 displays the schedule screen as illustrated in FIG. 26B on the display 508 of the communication terminal 7 (S55). The schedule screen as illustrated in FIG. 26B displayed at S55 is different from the schedule screen as illustrated in FIG. 25B displayed at S15 in that the reservation for image capturing has already been made. Specifically, as illustrated in FIG. 26B, the schedule screen displayed at S55 includes schedule information 7410 indicating the content of the reservation for image capturing processed at S16 to 18.

Next, when the supervisor Y selects the schedule information 7410, for example, with the keyboard 511 or the mouse 512, the reception unit 72 receives an instruction for acquiring the layout map associated with the schedule information 7410 (S56). In response to receiving the instruction by the reception unit 72, the data exchange unit 71 sends a request for the layout map to the image management system 5 (S57). This request for the layout map includes the site ID, the capturing start date and time, and the capturing end date and time. Thus, the data exchange unit 51 of the image management system 5 receives the request for the layout map from the communication terminal 7.

Next, the data storage/read unit 59 of the image management system 5 searches the site management table (see FIG. 16) with the site ID received at S57 as a retrieval key to read out the file name of the layout map and the device ID associated with the site ID (S58). Further, the data storage/read unit 59 searches the terminal management table (see FIG. 17) with the read-out device ID as a retrieval key to read out the file name of the device installation position information and the predetermined-area information associated with the device ID (S58).

Next, the generation unit 54 generates the layout map using those information read out at S58 (S59). The data exchange unit 51 transmits data of the layout map to the communication terminal 7 (S60). Thus, the data exchange unit 71 of the communication terminal 7 receives the data of layout map from the image management system 5. The display controller 73 displays the site status screen as illustrated in FIG. 27A on the display 508 of the communication terminal 7 (S61). The layout map is displayed in an upper half area of the site status screen. The layout map includes one more icons having a shape of pin, each indicating a position where an image is captured in the site.

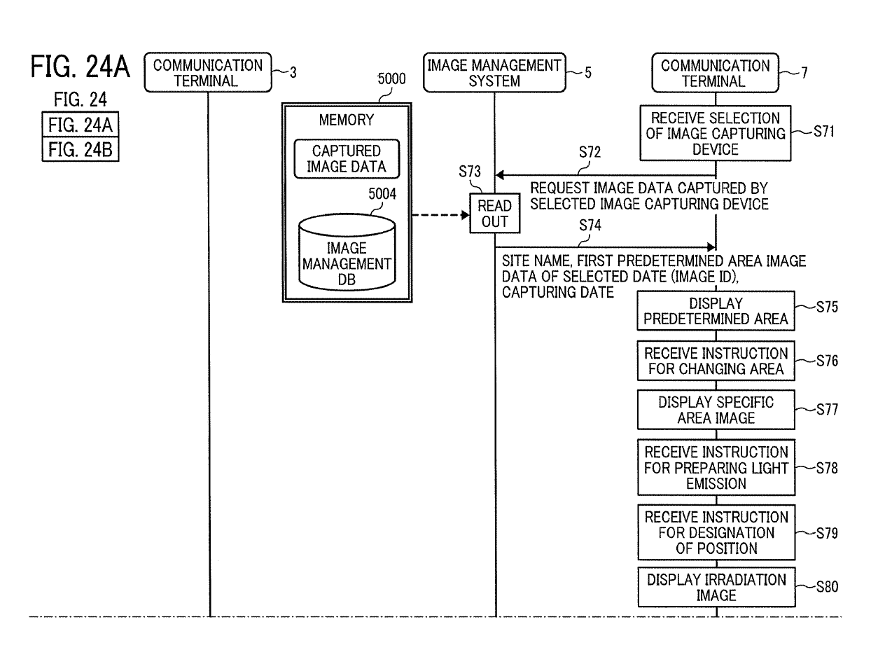

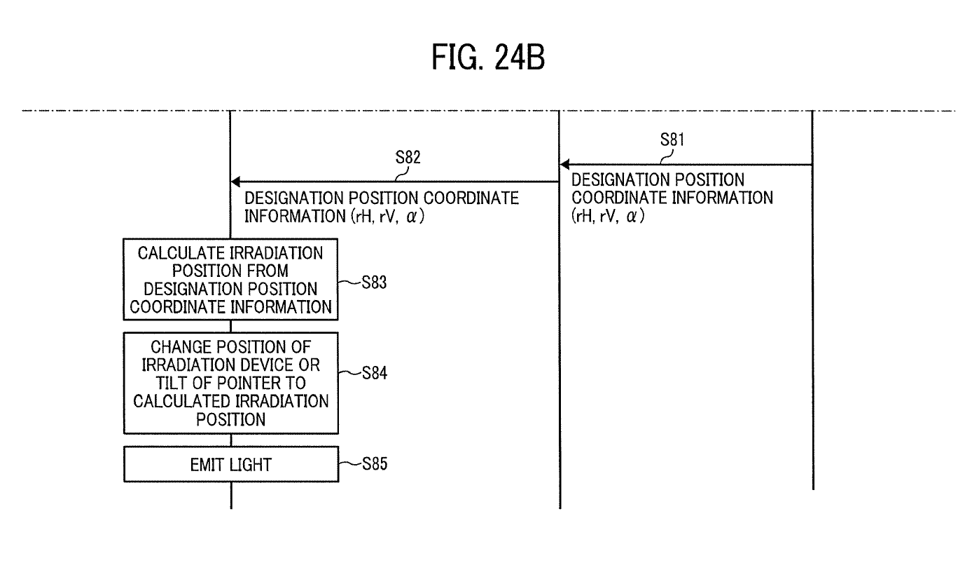

Hereinafter, a description is given of displaying the captured image data with reference to FIGS. 24A and 24B. FIGS. 24A and 24B is a sequence diagram illustrating an operation of displaying the captured image data.

First, as illustrated in FIG. 24A, when the supervisor Y selects a desired pin-shaped icon with the cursor 4, the reception unit 72 receives an instruction for selecting the image capturing device 1 (S71). In response to receiving the instruction by the reception unit 72, the data exchange unit 71 sends a request for the captured image data captured by the selected image capturing device 1 (S72). This request includes the device ID associated with selected image capturing device 1. Thus, the data exchange unit 51 of the image management system 5 receives the request for the captured image data from the communication terminal 7. When selecting the desired pin-shaped icon, the cursor 4 is moved with the mouse 512.

Next, at S73, the data storage/read unit 59 of the image management system 5 searches the image management table (see FIG. 19) with the device ID received at S72 as a retrieval key to read out a first one of the file names of captured image data associated with the device ID. In addition, at S73, the data storage/read unit 59 retrieves the captured image data corresponding to the read-out file name from the memory 5000.

The data exchange unit 51 of the image management system 5 transmits, to the communication terminal 7, the site name, a first one of the captured image data of the selected date and time, and the capturing date and time (S74). The data exchange unit 51 also transmits the image ID corresponding to the captured image data together with the captured image data. Thus, the data exchange unit 71 of the communication terminal 7 receives the site name, the first one of the captured image data of the selected date and time, and the capturing date and time.

Next, as illustrated in FIG. 29, the display controller 73 of the communication terminal 7 displays the predetermined-area image below the layout map on the site status screen (S75). Further, a “pointer off” key is displayed in the lower right corner on the site status screen. The supervisor Y selects the “pointer off” key to input an instruction for remotely causing the irradiation device 380 to emit laser light at the construction site.

The reception unit 72 receives an instruction from the supervisor Y for changing the predetermined-area image in accordance with movement of the cursor 4 in left, right, up, and down directions (S76). In response to receiving the instruction, the display controller 73 displays another predetermined-area image in the same full spherical panoramic image on the display 508, as illustrated in FIG. 29 (S77). The another predetermined-area image displayed in response to the instruction for changing the current predetermined-area image is hereinafter referred to as a “specific-area image”.

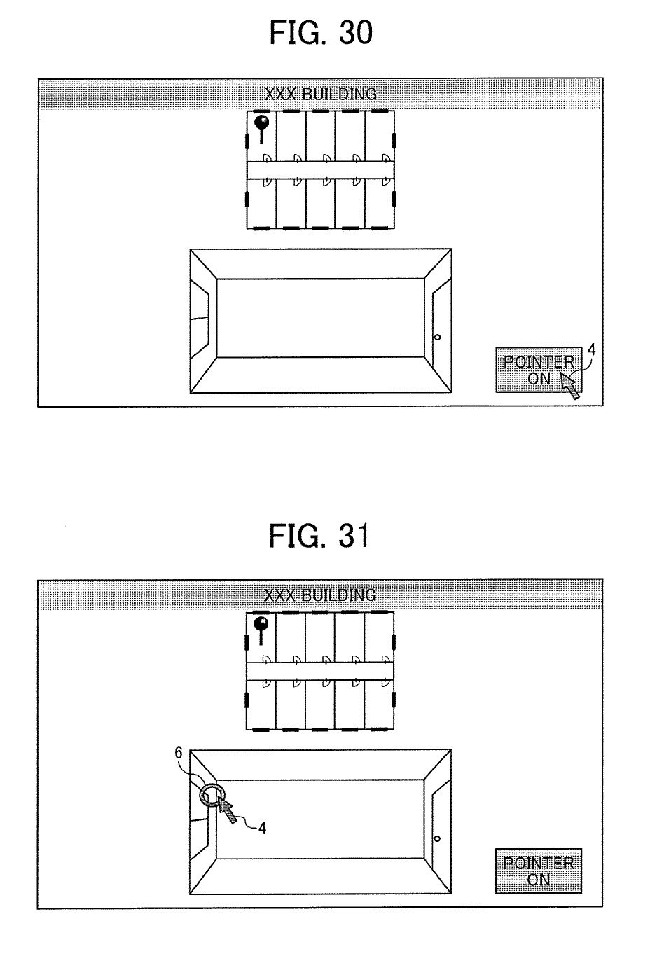

Thereafter, when the supervisor Y operates the mouse moves cursor 4 to select the “pointer off” key, the reception unit 72 receives an instruction for preparation for emitting laser light (S78). Accordingly, the display controller 73 changes the “pointer off” key to a “pointer on” key as illustrated in FIG. 30.

Next, when the supervisor Y operates the mouse 512 to moves cursor 4 to a desired position in the specific-area image (for example, a part of a window frame in FIG. 31) and double-clicks the desired position, the reception unit 72 receives an instruction for designating the designation position to be irradiated with laser light (S79). In response to receiving the instruction, the display controller 73 visually displays an irradiation image 6 illustrated in FIG. 31 (S80). Further, the data exchange unit 71 transmits specific position coordinate information indicating a coordinate (rH, rV, α) of the designation position in the same coordinate system as that of the full spherical panoramic image (S81). Thus, the data exchange unit 51 of the image management system 5 receives the designation position coordinate information from the communication terminal 7.

The data exchange unit 51 of the image management system 5 transfers the designation position coordinate information to the communication terminal 3 (S82). Thus, the data exchange unit 31 of the communication terminal 3 receives the designation position coordinate information from image management system 5.

In the communication terminal 3, the calculation unit 34 transforms the coordinate system of the full spherical panoramic image in the image capturing device 1 to the coordinate system of a space of the site where the communication terminal 3 is positioned to calculate, from the designation position coordinate information received at S82, the irradiation position irradiated with laser light in the space of the site (S83). As the image capturing device 1 is mounted to the communication terminal 3 as illustrated in FIG. 10A such that the image pickup device 103a 1 always faces in a specific direction relative to the communication terminal 3, it is possible to perform coordinate transformation as described above.

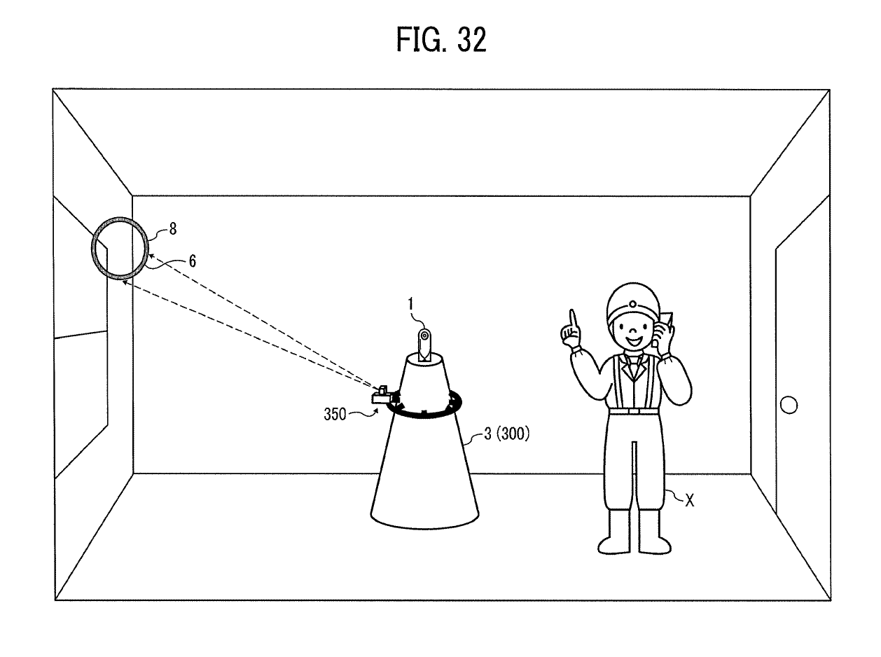

Next, the change unit 35 changes at least one of the position of the irradiation device 380 and the tilt of the pointer 381 toward the irradiation position calculated at S83 (S84). In a case where the irradiation device 380 and the pointer 381 already face toward the irradiation position calculated at S83, the change unit 35 does not change the position of the irradiation device 380 and the tilt of the pointer 381. Next, the light emission unit 36 starts emitting laser light (S85). Thus, in the site such as a construction site, the irradiation device 380 irradiates an irradiation position 8 with laser light as illustrated in FIG. 32 (S85). With the configurations and operations as described heretofore, the supervisor Y using the communication terminal 7 is able to instruct a work position and the like visually to the worker X at a remote location such as the construction site. Accordingly, the supervisor Y is able to tell the work to do over the phone, for example.

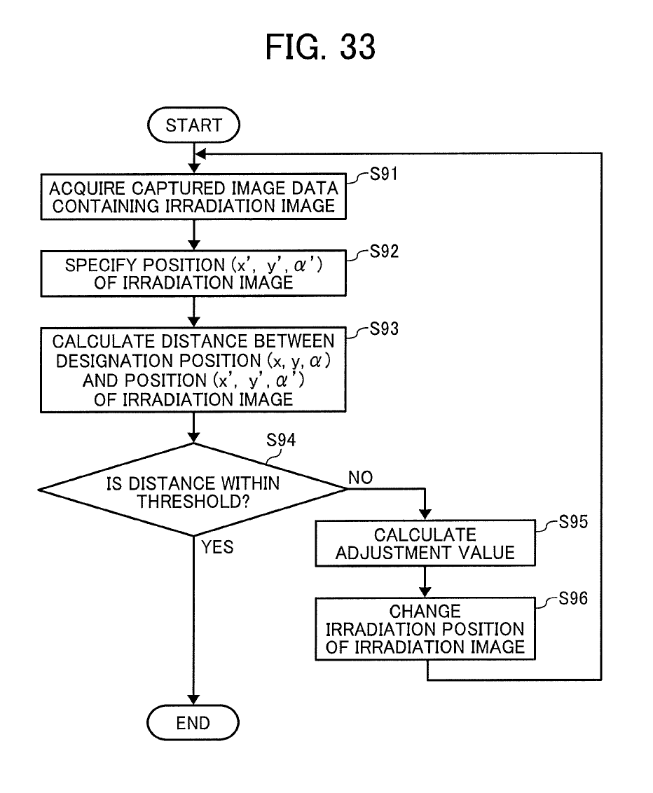

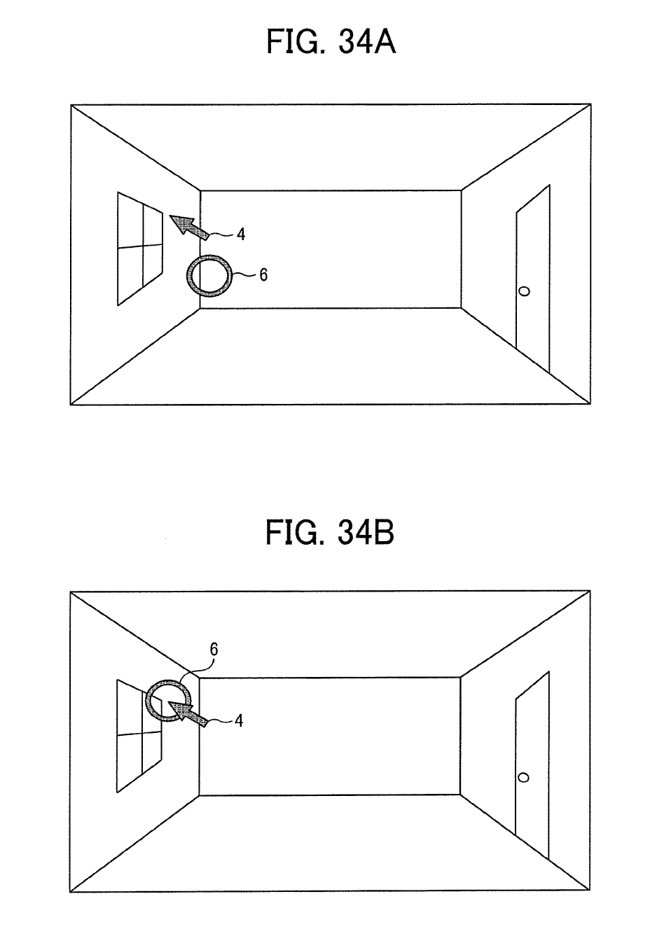

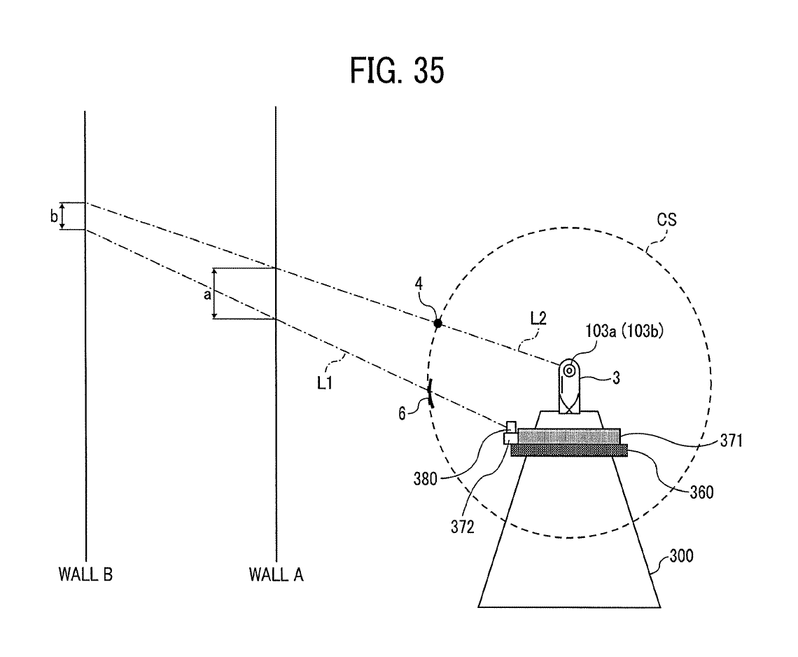

Hereinafter, a description is given of an operation of controlling a movement of the irradiation position 8 of the irradiation image 6 with reference to FIGS. 33 to 35. FIG. 33 is a flowchart illustrating an operation of controlling a movement of an irradiation position 8 of the irradiation image 6. FIGS. 34A and 34B each illustrates an example of a screen displayed on the display 508 of the communication terminal 7 for explaining a relation between the cursor 4 and the irradiation position 8 of the irradiation image 6. FIG. 35 is an illustration for explaining a relation between the cursor 4 and the irradiation position 8 of the irradiation image 6.

First, the connection unit 38 of the communication terminal 3 acquires the captured image data containing the irradiation image 6 as illustrated in FIG. 32 from the image capturing device 1 (S91). Next, the calculation unit 34 determines the position (x′, y′, α′) of the irradiation image 6 in the full spherical image (S92). Further, the calculation unit 34 calculates a distance between the designation position (x, y, α) designated by the cursor 4 and the position (x′, y′, α′) of the irradiation image 6 (S93). For example, FIG. 34 illustrates a view of the screen on which the designation position designated by the cursor 4 is away from the irradiation image 6.

Hereinafter, a description is given of a relation between the cursor 4 and the irradiation position 8 of the irradiation image 6 with reference to FIG. 35. The solid sphere CS is in a virtual space in fact in the same way as the solid sphere CS of FIGS. 5 and 6A. However, FIG. 35 visually illustrates the solid sphere CS in order to explain the relation between the cursor 4 and the irradiation image 6. As illustrated in FIG. 35, as a position of the image pickup device 103a (103b) and a position of the irradiation device 380 is different from each other, a straight line L1 passing through the irradiation device 380 and the irradiation image 6 is not parallel to a straight line L2 passing through the image pickup device 103a and the cursor 4. Further, assuming that there are a wall A and a wall B, which are away from the communication terminal 3 respectively by different distances, the distances between the cursor 4 and the irradiation position 8 of the irradiation image 6 are different from each other in the real space. For example, in FIG. 35, a distance between the designation position designated by the cursor 4 and the irradiation image 6 on the wall A, which is closer to the image pickup device 103a than the wall B, is distance “a”. By contrast, a distance between the designation position designated by the cursor 4 and the irradiation image 6 on the wall B, which is farther away from the image pickup device 103 than the wall A, is a distance “b”. The distance “a” and the distance “b” are different from each other. Feedback control starting from S94 as described below is performed for adjusting this difference.

The determination unit 33 determines whether the distance calculated at S93 by the calculation unit 34 is with the threshold (S94). When the distance is within the threshold (S94: YES), the processing ends. By contrast, when the distance exceeds the threshold (S94: NO), the calculation unit 34 calculates an adjustment value from the distance between the designation position (x, y, a) designated by the cursor 4 and the position (x′, y′, α′) of the irradiation image 6 (S96). The change unit 35 changes the irradiation position 8 of the irradiation image 6 such that the distance between the designation position (x, y, a) and the position (x′, y′, α′) of the irradiation image 6 is reduced. With this operation, as illustrated in FIG. 34B, the designation position designated by the cursor 4 and the position of the irradiation image 6 is reduced such that the cursor 4 and the irradiation image 6 overlap with each other at least in part.

When a typical full spherical camera is placed near a center of the space to be captured in a construction site, the camera should be installed on a tripod and the like. In this case, the worker is likely to stumble over the camera and make the full spherical camera fall down by mistake. By contrast, as described heretofore, according to this embodiment, the image capturing device 1 is detachably mounted to the safety equipment such as the traffic cone 300 constituting the communication terminal 3. The communication terminal 3 acquires data of the full spherical panoramic image from the image capturing device 1 mounted thereto to transmit the data to the communication terminal 7 via the communication network 9. Because the safety equipment, which is familiar in the construction site, constitutes the communication terminal 3, the worker is able to conduct works at the site while being aware of (or avoiding) the safety equipment. Accordingly, the worker is less likely to stumble over the communication terminal 3 and make the communication terminal 3 fall down by mistake. Especially, in a case where the safety equipment is implemented by the traffic cone 300, the safety equipment is placed at different positions according to daily situations.

Furthermore, as illustrated in FIG. 32, the irradiation position control unit 350 controls the irradiation device 380 to irradiate the irradiation position 8 with laser light at the site such as a construction site. With such configuration, the supervisor Y is able to instruct a work position and the like visually to the worker X at a remote location. Accordingly, the supervisor Y is able to tell the work to do to the worker X over the phone.

The image management system 5 is implemented by either a single computer or a plurality of computers, each including or performing at least a part of the functional blocks, operations, or memories of the image management system 5 as described above.

A recording medium such as a CD-ROM storing the programs in the above embodiment and the HD 504 storing those programs may be distributed domestically or internationally.

Numerous additional modifications and variations are possible in light of the above teachings. It is therefore to be understood that within the scope of the appended claims, the disclosure of the present invention may be practiced otherwise than as specifically described herein. For example, elements and/or features of different illustrative embodiments may be combined with each other and/or substituted for each other within the scope of this disclosure and appended claims.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

As described above, the present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet.

What is claimed is:

1. A safety equipment comprising:
a mounting part to which an image capturing device is detachably mounted, the image capturing device capturing an image of an object to acquire data of a full spherical panoramic image;
circuitry to acquire the data of the full spherical panoramic image from the image capturing device mounted to the mounting part; and
a transmitter to transmit the acquired data of the full spherical panoramic image to a communication terminal through a communication network, the communication terminal outputting an image based on the acquired data of the full spherical panoramic image.

2. The safety equipment according to claim 1, wherein the transmitter transmits the acquired data of the full spherical panoramic image to the communication terminal via an image management system through the communication network.

3. The safety equipment according to claim 1, further comprising:
an irradiation device to irradiate the object with laser light,
a receiver to receive position-coordinate information indicating a designation position in a coordinate system of the full spherical panoramic image, the designation position being designated by a user at the communication terminal,
wherein the circuitry is further configured to change at least one of a position of the irradiation device and a tilt of the irradiation device based on the received position-coordinate information.

4. The safety equipment according to claim 3, wherein the circuitry is further configured to:
transform the coordinate system of the full spherical panoramic image in the image capturing device to a coordinate system of a site where the safety equipment is located;
calculate an irradiation position at the site to which the laser light is to be emitted based on the transformed coordinate system; and
change at least one of the position of the irradiation device and the tilt of the irradiation device such that the irradiation device emits the laser light to the calculated irradiation position at the site.

5. The safety equipment according to claim 1, wherein the safety equipment is a traffic cone.

6. An image communication system comprising:
the safety equipment of claim 1; and
a communication terminal connected to the safety equipment via a communication network and to receive the data of the full spherical panoramic image from the image capturing device detachably mounted on the safety equipment.

7. The image communication system according to claim 6, further comprising:
an image management system connected to the safety equipment and the communication terminal via the communication network,
wherein the full spherical panoramic image is transmitted from the safety equipment to the communication terminal via the image management system.

8. A method for controlling light emission, comprising:
receiving a position-coordinate information indicating a designation position in a coordinate system of a full spherical panoramic image, the full spherical panoramic image being captured at an image capturing device mounted on a safety equipment located at a first site, and the position-coordinate information being received from a communication terminal located at a second site remote from the first site,
changing at least one of a position of an irradiation device located at the first site and a tilt of the irradiation device based on the received position-coordinate information to obtain an irradiation position at the first site to which the laser light is to be emitted; and
controlling the irradiation device to emit laser light to the irradiation position at the first site.

9. The method according to claim 8, further comprising:
transmitting data of the full spherical panoramic image captured at the image capturing device to the communication terminal through a communication network for output through the communication terminal,
wherein the designation position is selected from the full spherical panoramic image by a user at the communication terminal.

10. A non-transitory computer-readable medium storing a computer-executable program causing a computer to perform a method of controlling light emission, comprising:
receiving a position-coordinate information indicating a designation position in a coordinate system of a full spherical panoramic image, the full spherical panoramic image being captured at an image capturing device mounted on a safety equipment located at a first site, and the position-coordinate information being received from a communication terminal located at a second site remote from the first site;
changing at least one of a position of an irradiation device located at the first site and a tilt of the irradiation device based on the received position-coordinate information to obtain an irradiation position at the first site to which the laser light is to be emitted; and
controlling the irradiation device to emit laser light to the irradiation position at the first site.
